(19) United States
(12) Patent Application Publication
(10) Pub. No.: US 2025/0181408 A1
(43) Pub. Date: Jun. 5, 2025

(54) GRAPHICS PROCESSORS

(71) Applicant: Arm Limited, Cambridge (GB)

(72) Inventors: Philip Carlos Garcia, Austin, TX (US); Olof Henrik Uhrenholt, Lomma (SE); Wing-Tsi Henry Wong, Lund (SE); Mark Underwood, Cambridge (GB)

(73) Assignee: Arm Limited, Cambridge (GB)

(21) Appl. No.: 18/524,500

(22) Filed: Nov. 30, 2023

(51) Int. Cl. G06F 9/50; G06T 1/20; G06T 15/00

(52) U.S. Cl. CPC G06F 9/5038; G06T 1/20; G06T 15/005

(57) ABSTRACT

Disclosed is a method of operating a graphics processor when performing a processing pass that includes an initial “pilot” processing job that executes a respective initial “pilot” shader program that is to be executed in advance of a corresponding “main” shader program that will be executed for a separate “main” processing job within the same processing pass. A “main” processing job is permitted to be issued for processing concurrently with an initial “pilot” processing job on which it depends. To enforce dependencies between “main” and “pilot” shader execution in this case it is tracked whether any initial “pilot” processing jobs are currently being processed by the set of one or more processing cores and processing of tasks for “main” processing jobs is controlled accordingly.

### BACKGROUND

The technology described herein relates to performing data processing using graphics processors, and in particular to the operation of a graphics processor when performing a sequence of processing jobs that includes one or more initial “pilot” processing jobs (wherein, as will be explained further below, an initial “pilot” processing job executes a respective “pilot” shader program that is to be executed in advance of a corresponding “main” shader program that will be executed for a separate “main” processing job in the sequence of processing jobs).

Modern graphics processors typically include one or more processing (shader) cores, that execute, inter alia, programmable processing stages, commonly referred to as “shaders”, of a graphics processing pipeline that the graphics processor implements.

A graphics processor processing (shader) core is thus a processing unit that performs processing by running (typically small) programs for each “work item” in an output to be generated. In the case of generating a graphics output, such as a render target, such as a frame to be displayed, a “work item” in this regard may be a sampling position, e.g., in the case of a fragment shader, but could also be a vertex, or a ray, for example, depending on the graphics processing (shading) operation in question. In the case of compute shading operations, each “work item” in the output being generated will be, for example, the data instance (item) in the work “space” that the compute shading operation is being performed on.

A shader program to be executed by a given “shader” of a graphics processing pipeline will typically be provided by the application that requires the graphics processing using a high-level shader programming language, such as GLSL, HLSL, OpenCL, etc. This shader program will typically consist of “expressions” indicating desired programming steps defined in the relevant language standards (specifications). The high-level shader program is then translated by a shader language compiler to binary code for the target graphics processing pipeline. This binary code will consist of “instructions” which are specified in the instruction set specification for the given target graphics processing pipeline. The compilation process for converting the shader language expressions to binary code instructions may take place via a number of intermediate representations of the program within the compiler. Thus, the program written in the high-level shader language may be translated into a compiler specific intermediate representation (and there may be several successive intermediate representations within the compiler), with the final intermediate representation being translated into the binary code instructions for the target graphics processing pipeline.

Thus, references to “expressions” herein, unless the context otherwise requires, refer to shader language constructions that are to be compiled to a target graphics processor binary code (i.e. are to be expressed in hardware micro-instructions). Such shader language constructions may, depending on the shader language in question, be referred to as “expressions”, “statements”, etc. (for convenience, the term “expressions” will be used herein, but this is intended to encompass all equivalent shader language constructions such as “statements” in GLSL). “Instructions” correspondingly refers to the actual hardware instructions (code) that are emitted to perform an “expression”.

In order to execute shader programs, a graphics processor will include an appropriate execution unit or units (circuit or circuits) for that purpose. The execution unit(s) will include programmable processing circuit(s) for executing shader programs (the “shaders” of graphics processing pipeline).

The actual data processing operations that are performed by the execution unit when executing that shader program are usually performed by respective functional units of the execution unit, which may include (but are not limited to) a texture mapping unit that is configured to perform certain texturing operations. Thus, the functional units will in response to and as required by instructions in a (shader) program being executed perform appropriate data processing operations.

In addition to the programmable execution unit that executes the shader programs (using its associated functional units) the graphics processor processing (shader) core may typically also include one or more essentially fixed-function (hardware) stages for implementing certain stages of the graphics processing (rendering) pipeline. These fixed-function stages can be used to handle certain “frontend” processing operations that are to be performed in advance of the shader program. For instance, in the case of a rendering job for which a fragment shader is to be executed, the “frontend” processing operations may include, for example, operations such as primitive list reading, resource allocation, vertex fetching, rasterisation, early depth/stencil testing, etc., that set up the required state for executing the fragment shader program that performs the actual rendering operations that produce the desired graphics processing output (render target), such as a frame for display. Certain post-shader actions (such as late depth/stencil testing or tile write-out) may also be handled using essentially fixed-function (hardware) stages. Various arrangements would however be possible in this respect, e.g. depending on the particular configuration of the graphics processing pipeline and the type of processing job that is being performed.

Typically there may be many parallel processing (shader) cores within a graphics processor such that the graphics processor is capable of simultaneously processing plural different tasks in parallel. Thus, in a tile-based rendering system, for example, in which a render output is subdivided into plural rendering tiles for processing, respective tasks for rendering different tiles (tasks) may be issued to different processing (shader) cores such that the tiles can be rendered in parallel. Each graphics processor processing (shader) core is thus operable and configured to implement an instance of the graphics processing pipeline for processing a given rendering task that has been allocated to it. This can therefore provide a more efficient graphics processor operation.

Thus, when the graphics processor receives a set of commands from a host processor (e.g. CPU) that is executing an application that requires graphics processing to be performed to perform a particular processing “pass” (which processing pass may generally include a certain sequence of one or more processing “jobs” each generating a particular output for the processing “pass”, and wherein each processing “job” may typically comprise a respective set of one or more tasks that are to be processed for the particular output associated with the processing job), the commands are then processed within a suitable command processing unit (e.g. a command stream frontend/job manager) of the graphics processor to identify the processing jobs to be performed, and a suitable task iterator then schedules the processing of the respective tasks to be performed for the processing jobs for the processing pass accordingly, with the tasks being allocated to the available processing (shader) cores for processing. When a task is allocated to a processing (shader) core for processing, the processing (shader) core is thus operable and configured to load the required data for setting up the shader program through the “frontend” processing stages and then execute the desired shader program to produce the desired output. The output of the rendering task can then be (and is) written out accordingly.

Although the graphics processor operation is described above in relation to a single processing pass, it will be appreciated that a graphics processor may generally be operated to perform multiple processing passes, e.g. for producing a set of frames, e.g. for display. The different processing passes in a sequence of processing passes being performed may in some cases be independent of each other (e.g. where they relate to different frames, or exclusively write to different (data buffers). However, it is often the case that at least some of the different processing passes in a sequence of processing passes being performed are related to each other. It is also the case that different processing jobs within a particular processing pass may depend on each other, such that in a given sequence of processing jobs to be performed as part of a particular processing pass, there may be certain data (processing) dependencies between processing jobs that if not enforced may lead to certain artefacts in the final output.

A particular example of this would be when the graphics processor is performing a processing pass in which a sequence of processing jobs is to be performed that includes one or more initial “pilot” processing jobs, wherein an initial “pilot” processing job within a sequence of processing jobs executes a respective “pilot” shader program that is to be executed in advance of a corresponding “main” shader program that will be executed by a separate “main” processing job later in the sequence of processing jobs (i.e. within the same processing pass).

For example, it may be possible to identify the presence of expressions in a shader program to be executed that will operate on run time (i.e. when the application is being executed) constant inputs, and then, in effect, extract those expressions and execute them in a separate, initial, “pilot” shader program in advance of the “main” shader program. The initial “pilot” shader program may thus execute certain constant program expressions of an original shader program in an initial “pilot” shader program for the original shader program in advance of a separate subsequent “main” shader program. The subsequent “main” shader program can then use the results of the initial pilot shader program. In this case, the processing pass may therefore include one or more initial “pilot” processing jobs that are followed by a subsequent set of “main” processing jobs that are dependent on the one or more initial “pilot” processing jobs (as the “main” shader program should not be executed by any processing (shader) core in respect of any task for any “main” processing job until the corresponding initial “pilot” shader program or programs that are to be executed in advance of the “main” shader program have been executed such that there is a strict processing dependency between “main” and “pilot” shader program execution within the (same) processing pass).

The use of such “pilot” shader programs is described, for example, in U.S. Pat. No. 9,189,881, assigned to Arm Limited, the entire content of which is incorporated herein by reference.

The Applicants, however, believe that there remains scope for improvements to the operation of a graphics processor when performing a sequence of processing jobs that includes one or more initial “pilot” processing jobs (wherein an initial “pilot” processing job executes a respective “pilot” shader program that is to be executed in advance of a corresponding “main” shader program that will be executed for a separate “main” processing job in the sequence of processing jobs).

### BRIEF DESCRIPTION OF THE DRAWINGS

A number of embodiments of the technology described herein will now be described by way of example only and with reference to the accompanying drawings, in which:

FIG. 1 shows an exemplary computer graphics processing system;

FIG. 2 shows schematically a graphics processing pipeline that can be operated in the manner of the technology described herein;

FIG. 3 illustrates the use of “pilot” shader programs within the technology described herein;

FIG. 4 shows schematically the scheduling of graphics processor work to graphics processor shader cores according to an embodiment;

FIG. 5A illustrates a job issuing flow according to an embodiment;

FIG. 5B illustrates a job completion flow according to an embodiment;

FIG. 6A illustrates a task issuing flow according to an embodiment;

FIG. 6B illustrates a task completion flow according to an embodiment;

FIG. 7 illustrates a task processing flow according to an embodiment; and

FIG. 8 shows schematically the scheduling of graphics processor work to graphics processor shader cores according to another embodiment.

### DETAILED DESCRIPTION

A first embodiment of the technology described herein comprises a method of operating a graphics processor comprising a set of one or more processing cores, the method comprising:
when performing a processing pass including one or more initial “pilot” processing jobs, wherein an initial “pilot” processing job executes a respective initial “pilot” shader program that is to be executed in advance of a corresponding “main” shader program that will be executed for a separate “main” processing job within the same processing pass, the “main” shader program thus having a dependency on the initial “pilot” shader program for the initial “pilot” processing job, and wherein a “main” processing job comprises a respective set of one or more tasks to be processed for the “main” processing job, each task operable to execute a respective instance of the “main” shader program:
tracking whether any initial “pilot” processing jobs are currently being processed by the set of one or more processing cores; and
when a respective task to be processed as part of a “main” processing job is issued to a respective processing core for processing whilst the set of one or more processing cores is concurrently performing processing for at least one initial “pilot” processing job:
controlling processing of the task for the “main” processing job within the processing core based on the tracking whether any initial “pilot” processing jobs are currently being processed by the set of one or more processing cores such that the “main” shader program for the “main” processing job is not executed in respect of the task at least until any initial “pilot” processing jobs that were being concurrently processed with the task and on which the “main” shader program has a dependency have finished their processing.

A second embodiment of the technology described herein comprises a graphics processor comprising:
a set of one or more processing cores;
a task issuing circuit operable and configured to issue tasks to the set of one or more processing cores for processing; and
a control circuit,
wherein the control circuit is configured to:
when the graphics processor is performing a processing pass including one or more initial “pilot” processing jobs, wherein an initial “pilot” processing job executes a respective initial “pilot” shader program that is to be executed in advance of a corresponding “main” shader program that will be executed for a separate “main” processing job within the same processing pass, the “main” shader program thus having a dependency on the initial “pilot” shader program for the initial “pilot” processing job, and wherein a “main” processing job comprises a respective set of one or more tasks to be processed for the “main” processing job, each task operable to execute a respective instance of the “main” shader program:
track whether any initial “pilot” processing jobs are currently being processed by the set of one or more processing cores; and
control processing of tasks for “main” processing jobs within the processing cores based on the tracking whether any initial “pilot” processing jobs are currently being processed by the set of one or more processing cores such that, when a respective task to be processed as part of a “main” processing job is issued to a respective processing core for processing whilst the set of one or more processing cores is concurrently performing processing for at least one initial “pilot” processing job:
the “main” shader program for the “main” processing job is not executed in respect of the task at least until any initial “pilot” processing jobs that were being concurrently processed with the task and on which the “main” shader program has a dependency have finished their processing.

The technology described herein relates to graphics processor operation in which certain (e.g. constant) program expressions of an original shader program can be executed in an initial “pilot” shader program for the original shader program in advance of a separate subsequent “main” shader program. The subsequent “main” shader program can then use the results of the initial “pilot” shader program. In this way, the instructions emitted for a constant program expression, for example, may be executed only once in the initial pilot shader program, rather than having to be executed multiple times in the corresponding original shader program each time the result for the expression in question is required. This can therefore remove repeated calculations from the shading process.

As will be explained further below, an initial “pilot” shader program is thus extracted from an original shader program and associated with a set of one or more subsequent “main” shader programs that have been extracted from the (same) original shader program. An original shader program (e.g. as provided by an application) is thus, in effect, split into an initial “pilot” shader program and a corresponding set of one or more subsequent “main” shader programs that will accordingly have a data (processing) dependency on the initial “pilot” shader program (or programs) with which they are associated.

This type of “initial” shader program (or “pre-shader” program) will be referred to herein as a “pilot” shader program (it will be appreciated however that the term “pilot” shader program is intended to encompass any and all equivalent such arrangements in which certain parts of an original shader program may be executed by an initial shader program that is executed separately and in advance of a corresponding “main” shader program that uses the results of the initial shader program (such that the “main” shader program has a data (processing) dependency on the initial shader program)).

An initial “pilot” shader program can thus be (and generally is) executed as part of a respective initial “pilot” processing job, wherein the initial “pilot” processing job serves to execute the desired initial “pilot” shader program, and write the results of the initial “pilot” shader program out appropriately such that the results of the initial “pilot” shader program execution can then be used as required by corresponding “main” shader programs that will be executed as part of subsequent “main” processing jobs (but which initial “pilot” processing job in embodiments serves only to produce such intermediate results, i.e. by executing the initial “pilot” shader program, and does not, for example, produce a part of a final render output, e.g. for display, which final render output will instead be produced by one or more subsequent “main” processing jobs).

The technology described herein thus relates generally to the operation of a graphics processor when performing a processing pass including a sequence of processing jobs that includes one or more such initial “pilot” processing jobs, wherein, as explained above, an initial “pilot” processing job executes a respective “pilot” shader program that is to be executed in advance of a corresponding “main” shader program that will be executed for a separate “main” processing job in the (same) sequence of processing jobs (processing pass). In this case, the execution of the “main” shader program associated with the “main” processing job depends on the results of executing the respective initial “pilot” shader program or programs that are executed for the one or more initial processing jobs (such that the “main” shader program should not be executed until its initial “pilot” shader program or programs have been executed), and the “main” processing job thus has a data (processing) dependency on the one or more initial “pilot” processing jobs.

Typically (and in embodiments), the same graphics processor command stream is responsible for launching both the initial “pilot” processing jobs and the corresponding, dependent “main” processing jobs.

In some more traditional graphics processor arrangements, a strict (hard) processing barrier is enforced between processing jobs within the graphics processor command stream to cause the graphics processor to explicitly wait until an earlier processing job has completed its processing before issuing a later processing job for processing. In the situation described above where the command stream includes one or more initial “pilot” processing jobs, this processing barrier thus guarantees that any initial “pilot” shader programs will be executed in advance of a corresponding dependent “main” shader program, since the processing job including the “main” shader program will not be issued from the command stream for processing until the one or more initial “pilot” processing jobs have completed their processing.

The present Applicants recognise, however, that executing such initial “pilot” shader programs can often take a few thousand cycles during which there is typically relatively lower utilisation of the graphics processor's set of processing cores. For instance, modern graphics processors typically include a larger number of processing cores, and the present Applicants have found that in more traditional arrangements where a strict (hard) processing barrier is enforced between different processing jobs, because the processing cores cannot start performing any processing for the next processing job until the current processing job has finished, it is often the case when an initial “pilot” processing job is being performed that most of the processing cores are idle for many processing cycles waiting for “pilot” shader program execution on a single processing core to finish.

The present Applicants thus recognise that it would be beneficial to remove such strict (hard) processing barriers between initial “pilot” processing jobs and subsequent dependent “main” processing jobs, i.e. so as to allow the processing cores to run ahead of their current command stream execution and start to perform at least some processing of a dependent “main” processing job concurrently with processing of a corresponding initial “pilot” processing job on which it depends, whilst still ensuring a safe (artefact-free) graphics processing operation by ensuring that any dependencies between “pilot” and “main” shader program execution within a particular processing pass are appropriately enforced within the processing cores. The technology described herein provides a particularly efficient mechanism for doing this, as will be explained further below.

Thus, according to the technology described herein, the method comprises (the task issuing circuit (task iterator)) issuing tasks for “main” processing jobs to respective processing (shader) cores without waiting for any initial “pilot” processing jobs that may currently be being processed by the set of one or more processing (shader) cores to finish their processing.

This can then help reduce latency associated with execution of any initial “pilot” shader programs, since a “main” processing job that may require the results of the initial “pilot” shader program (such that the “main” processing job has a dependency on the corresponding initial “pilot” processing job) can according to the technology described herein be issued for processing relatively earlier, e.g., and in particular, such that at least some processing of the “main” processing job can be (and is) performed concurrently with execution of the initial “pilot” shader program on which it depends, so long as execution of the “main” shader program in respect of any tasks that are being processed as part of the “main” processing job for which the “main” shader program will be executed can be (and is) appropriately controlled (e.g. stalled) within the processing (shader) cores when required to enforce the dependency between the “main” shader program and its corresponding initial “pilot” shader program(s).

In this way, at least some tasks that are to be processed for a particular “main” processing job can effectively start to be ‘preloaded’ into processing (shader) cores for processing whilst the set of processing (shader) cores are currently performing processing for an initial “pilot” processing job on which the “main” processing job depends, e.g., and in particular, so that at least some “frontend” processing for those tasks, i.e. processing up to but not including execution of the “main” shader program associated with the “main” processing job (or any other processing that may depend on the “pilot” shader program execution), can be performed concurrently with execution of the “pilot” shader program on which the “main” shader program associated with the “main” processing job depends. This then means that when the initial “pilot” processing jobs for a given “main” processing job have completed (i.e. the initial “pilot” shader program or programs have all been executed), the subsequent (next) “main” processing job in the sequence of processing jobs being performed is already being processed within the processing (shader) cores such that a “main” shader program can be executed in respect of any tasks for the “main” processing job that have been preloaded into a processing (shader) core in this way relatively sooner (e.g., and in embodiments, immediately) after the corresponding “pilot” shader programs that are to be executed in advance of the “main” shader program have finished.

Thus, by pre-loading the “main” processing jobs into the processing cores in this way, with the dependencies on the initial “pilot” processing jobs being enforced within the processing cores, the technology described herein may reduce latency associated with performing such initial “pilot” processing jobs, and hence also improve processing (shader) core utilisation. Removing strict (hard) processing barriers in the command stream between initial “pilot” processing jobs and subsequent dependent “main” processing jobs also allows the task issuing circuit (task iterator) to run ahead (whereas in more traditional graphics processors where such strict (hard) processing barriers are enforced in the command stream, the task issuing circuit (task iterator) may stall waiting for the command processing unit (command stream frontend/job manager (circuit)) to create further jobs for it to process).

In this respect, the present Applicants recognise that so long as a “main” shader program is not executed in respect of any tasks that are to be processed for the “main” processing job including the “main” shader program before any corresponding initial “pilot” shader programs on which the “main” shader program depends have been executed, it is generally safe to start issuing tasks for a “main” processing job to the set of processing (shader) cores for processing, and to perform at least some frontend processing within the processing cores for those tasks for the “main” processing job (i.e. processing up to but not including execution of the “main” shader program or any processing that may be dependent on the results of the initial “pilot” shader program), concurrently with its corresponding initial “pilot” processing job (or jobs).

Thus, the technology described herein permits at least some processing for “main” processing jobs to overlap across the graphics processor's set of processing (shader) cores with processing of a corresponding initial “pilot” processing job on which the “main” processing job is dependent, in particular such that at least some frontend processing for a task for a “main” processing job can be performed concurrently with the processing of a corresponding initial “pilot” processing job (i.e. with “pilot” shader program execution), with the data (processing) dependency between the “main” and initial “pilot” shader programs associated with the processing jobs in question being enforced within the processing (shader) cores (in hardware) (e.g. rather than being enforced within the graphics processor command stream, as in the more traditional approach mentioned above).

Thus, by allowing the task issuing circuit (task iterator) to issue tasks for “main” processing jobs to respective processing (shader) cores for processing without necessarily waiting for any initial “pilot” processing jobs on which there may be a data (processing) dependency to finish their processing, it may be (and at least sometimes will be) the case that a task for a “main” processing job is used to a respective processing (shader) core for processing whilst the set of one or more processing (shader) cores is currently (still) performing processing for an initial “pilot” processing job on which at least the “main” shader program execution for the “main” processing job has a processing (data) dependency (which situation is avoided in more traditional arrangements due to the strict (hard) processing barrier between processing jobs). In this situation where a task for a “main” processing job is issued to a respective processing (shader) core for processing whilst the set of one or more processing (shader) cores is currently (still) performing processing for an initial “pilot” processing job on which there is a processing (data) dependency, according to the technology described herein additional control is performed for the processing of the task such that the “main” shader program for the “main” processing job is not executed in respect of the task at least until any initial “pilot” processing jobs that were being concurrently processed with the task and on which the “main” shader program has a dependency have finished their processing. This then allows any required data (processing) dependencies between “main” and initial “pilot” shader programs within a particular processing pass to be enforced within the processing (shader) cores as needed.

In particular, in order to enforce the data (processing) dependencies between the “main” and initial “pilot” shader programs within a particular processing pass, the technology described herein (when performing a processing pass that includes one or more initial “pilot” processing jobs) tracks whether any initial “pilot” processing jobs are currently being processed by the set of one or more processing cores. Thus, a suitable record is in embodiments maintained of whether (or not) the set of processing (shader) cores is currently performing any initial “pilot” processing jobs.

Subject to the particular requirements of the technology described herein, the tracking of whether any initial “pilot” processing jobs are currently being processed by the set of one or more processing (shader) cores may generally be performed in any suitable and desired manner (using any suitable record or data structure). Various arrangements would be possible in this regard.

For example, and in embodiments, the tracking is done by maintaining a reference counter that stores a count that is indicative of how many initial “pilot” processing jobs (if any) are currently being performed. In embodiments therefore, when a task to be processed as part of an initial “pilot” processing job is issued to the set of processing cores for processing, the reference counter is in embodiments incremented accordingly. Correspondingly, when a task for an initial “pilot” processing job finishes, the reference counter is in embodiments then decremented. The reference counter thus in embodiments tracks whether (or not) any tasks for any initial “pilot” processing jobs are currently being performed by (any of) the graphics processor's set of processing cores.

To facilitate this tracking, initial “pilot” processing jobs are in embodiments marked in the graphics processor command stream as separate from regular (e.g. “main”) processing jobs. For instance, as will be explained below, the initial “pilot” processing jobs are in embodiments created by a shader compiler that executes as part of a software driver for the graphics processor that prepares the graphics processor command streams. The driver can thus, and in embodiments does, mark initial “pilot” processing jobs accordingly within the command stream when preparing and submitting such command streams to the graphics processor for execution.

For example, the command streams received by the graphics processor are in embodiments processed by a suitable command processing unit (e.g. a command stream frontend/job manager (circuit)) of the graphics processor that is operable and configured to identify the presence of such initial “pilot” processing jobs and this identification is in embodiments done based on such marking of initial “pilot” processing jobs within the graphics processor command stream. This then provides a very simple and efficient mechanism for identifying any such initial “pilot” processing jobs within a graphics processor command stream (and hence triggering the particular operation of the technology described herein). Various other arrangements would however be possible and in general the identification of initial “pilot” processing jobs may be more or less complex as desired.

In embodiments, a task issuing circuit (task iterator) of the graphics processor is then responsible for breaking the processing jobs into respective tasks and controlling the scheduling and allocation of the respective tasks to graphics processor processing (shader) cores for processing. In this respect, it will be appreciated that a particular processing job may typically, and in embodiments does, comprise a plurality of separate processing tasks which processing tasks can then be allocated to processing cores for processing. For example, in a typical graphics processor there will be a plurality of processing cores. The allocation of tasks to processing cores may thus be, and in embodiments is, generally performed to try to balance the processing between the available processing (shader) cores of the graphics processor, and ensure higher utility of the available processing (shader) cores.

(Each task may in turn be broken down into smaller units of work for processing by the processing (shader) cores. For example, each task may generate multiple threads that each execute a separate instance of the shader program.)

The task issuing circuit (task iterator) of the graphics processor is thus in embodiments operable and configured to break processing jobs down into their respective tasks, which tasks are then issued for processing to respective processing (shader) cores of the graphics processor (and this task scheduling is in embodiments done, e.g., in the normal manner for scheduling tasks onto a set of processing (shader) cores of a graphics processor). These tasks can then be performed separately, e.g. in parallel, across different processing (shader) cores of the graphics processor. For example, in the context of a rendering job, the render output may be subdivided into a plurality of rendering tiles (or ‘metatiles’), with different tiles (‘metatiles’) being allocated to different processing (shader) cores for processing. Various arrangements would be possible in this regard.

Thus, any references herein to issuing a processing job to a processing (shader) core (or generally to the processing (shader) cores) for processing should be understood accordingly as in embodiments referring to issuing respective tasks from a plurality of tasks that are to be processed for the processing job in question to processing (shader) cores for processing. In this respect, it will be appreciated that different tasks within a processing may generally, and typically will be, allocated to different processing (shader) cores. Thus, a processing job may generally be performed across a plurality of different processing (shader) cores.

In embodiments, the tracking of whether any initial “pilot” processing jobs are currently being processed by the set of one or more processing (shader) cores is performed by the task issuing circuit (task iterator) of the graphics processor. In embodiments this is done as part of the normal task scheduling operation.

For example, in embodiments where the tracking is performed using a reference counter, as described above, the reference counter is in embodiments maintained by the task issuing circuit (task iterator) that controls the allocation and scheduling of tasks for the different processing jobs to the processing cores. Thus, in embodiments, the task issuing circuit (task iterator) when issuing a task for an initial “pilot” processing job to a processing (shader) core for processing is operable and configured to increment the reference counter accordingly. The task issuing circuit (task iterator) is thus able to easily track which (if any) processing (shader) cores are currently performing initial “pilot” processing jobs. Correspondingly, when a processing (shader) core finishes a task for an initial “pilot” processing job, this is in embodiments signalled to the task issuing circuit (task iterator) (e.g. as part of the normal job completion signalling to indicate that all tasks associated with the job have finished) to cause the reference counter to be decremented.

Thus, the reference counter in embodiments tracks how many tasks associated with initial “pilot” processing jobs are currently being performed. It will be appreciated in this respect that an initial “pilot” processing job may, and typically will, only contain a single task. Thus, in practice, there may be no difference between tracking at the job level or task level and both approaches can work effectively. However, in principle, an initial “pilot” processing job may contain any number of tasks and in that case the tracking may either be performed in respect of the individual tasks associated with the initial “pilot” processing job or for the initial “pilot” processing job as a whole, and various arrangements would be possible in this regard. For example, in the case where an initial “pilot” processing job may contain multiple tasks, the task issuing circuit (task iterator) may increment the reference counter only when issuing the first task for an initial “pilot” processing job, and decrement the reference counter only when all tasks associated with the initial “pilot” processing job have finished, and in this way the reference counter can be used to track whether any initial “pilot” processing jobs are currently being executed at the job level, if that is desired.

Thus, the tracking of whether any initial “pilot” processing jobs are currently being processed by the set of one or more processing (shader) cores is in embodiments performed globally across all of the processing (shader) cores within the set of one or more processing cores. That is, the tracking in embodiments tracks whether any of the processing (shader) cores are currently performing (any tasks for) an initial “pilot” processing job (in which case none of the processing (shader) cores should execute a “main” shader program associated with corresponding, subsequent “main” processing job until the initial “pilot” processing job has finished). For instance, as mentioned above, it is often the case that the initial “pilot” processing job is being performed by only a single processing (shader) core but this means that all of the other processing (shader) cores must wait for the initial “pilot” processing job to finish before executing any dependent “main” shader programs (and so the technology described herein provides a mechanism for handling this situation).

The tracking of whether (or not) the set of processing (shader) cores is currently performing any initial “pilot” processing jobs can then be (and is) used accordingly to control processing of (individual) tasks that are to be processed as part of a subsequent “main” processing job, e.g., and in embodiments, to enforce (when needed) any data (processing) dependencies between a “main” shader program that is to be executed as part of a “main” processing job and an initial “pilot” shader program that is to be executed in advance of the “main” shader program as part of a separate initial “pilot” processing job.

Thus, when a task that is to be processed for a particular “main” processing job is issued to a particular processing (shader) core for processing, it can be (and in embodiments is) determined based on such tracking (e.g., and in embodiments, by checking the reference counter when one is provided) whether or not any initial “pilot” processing jobs are currently being performed by any of the processing (shader) cores within the graphics processor's set of processing (shader) cores on which the “main” processing job is potentially dependent.

If it is determined that no initial “pilot” processing jobs are currently being performed (i.e. there are no tasks associated with an initial “pilot” processing job currently in-flight), no further control or checking needs to be performed in respect of that task. On the other hand, when it is determined that at least one task associated with an initial “pilot” processing job is currently being performed by (one or more of) the graphics processor's set of processing cores such that at least some tasks to be processed in respect of a particular “main” processing job will be issued for processing concurrently with an initial “pilot” processing job on which the “main” processing job is potentially dependent, appropriate control can then be (and is) performed for the tasks for the subsequent “main” processing job, e.g., and in embodiments, to stall execution of the “main” shader program, until it can be determined that the initial “pilot” processing job has finished its processing.

Thus, when a respective task to be processed as part of a “main” processing job is issued to a respective processing core for processing whilst the set of one or more processing cores is concurrently performing processing for at least one initial “pilot” processing job within the same processing pass as the “main” processing job for which the task is being performed, the technology described herein comprises controlling processing of the task for the “main” processing job within the processing core based on the tracking whether any initial “pilot” processing jobs are currently being processed by the set of one or more processing cores such that the “main” shader program for the “main” processing job is not executed in respect of the task at least until any initial “pilot” processing jobs for the current processing pass have finished.

The control that is performed to enforce the data (processing) dependencies is thus performed within the processing (shader) cores by controlling processing within individual tasks (i.e. the entities issued to respective processing (shader) cores for processing) (whereas the tracking is in embodiments performed at the level of processing jobs as a whole).

In this respect, it will be appreciated that the control may therefore, and typically will, need to be performed across different processing (shader) cores as different tasks that are to be processed for a particular “main” processing job may, and typically will, be allocated to different processing (shader) cores (and these may generally be different processing (shader) cores to the processing (shader) core or cores that are executing any initial “pilot” processing jobs).

Subject to the particular requirements of the technology described herein, this control can be done in various suitable ways, as desired.

For example, in some embodiments, this may be done by the processing (shader) core when processing a particular task for a “main” processing job explicitly checking, prior to execution of any “main” shader program, whether or not any initial “pilot” processing jobs are currently being performed by any (of the other) processing (shader) cores. In that case, the processing (shader) core may need to message the task issuing circuit (task iterator) at this point to perform a dependency check. The execution of the “main” shader program may then be gated pending a suitable response from the task issuing circuit (task iterator). For instance, once the task issuing circuit (task iterator) confirms that there are no initial “pilot” processing jobs currently being performed, this can be signalled back to the processing (shader) core that requested the dependency check, and that processing (shader) core can then execute the “main” shader program for the processing job that it is currently performing.

However, this approach may require increased signalling between the processing (shader) cores and the task issuing circuit (task iterator) as a separate dependency check may need to be checked for each task for each processing job.

Therefore, as another example, and in embodiments, the task issuing circuit (task iterator) is operable and configured to check when issuing a task for a “main” processing job to a processing (shader) core for processing whether or not any initial “pilot” processing jobs are currently being performed by any processing (shader) cores. That is, in an embodiment, the checking as to whether or not any initial “pilot” processing jobs are currently being performed by any of the processing (shader) cores is performed by the task issuing circuit (task iterator) when allocating a task to a processing (shader) core for processing. In this case, each task associated with a “main” processing job that is being allocated to a processing (shader) core for processing can thus be (and in this embodiment is) associated with a suitable indicator, e.g. flag, indicating whether (or not) (at the point at which the task is issued for processing) any initial “pilot” processing jobs are currently being performed by any processing (shader) cores.

In embodiments, therefore, if there are no initial “pilot” processing jobs being performed when a particular task for a subsequent “main” processing job is issued for processing, this is indicated accordingly for the task in question, and in that case no additional control (e.g. stalling) needs to be performed. In that case, the task can be processed, e.g. as normal, with the “main” shader program that is to be executed as part of the “main” processing job to which the task relates being executed immediately after any frontend processing for the task in question has finished.

In this respect it will be appreciated that the processing jobs should be and are in embodiments issued for processing in strict order such that any initial “pilot” processing jobs are issued for processing prior to any corresponding “main” processing jobs. Thus, if by the time a particular task for a particular “main” processing job is issued for processing there are no initial “pilot” processing jobs currently being performed by any of the processing (shader) cores, this means that it is guaranteed that any initial “pilot” processing jobs for that particular “main” processing job must already have finished, such that the results of any initial “pilot” shader programs executed as part of those initial “pilot” processing jobs must therefore be available for use by the “main” shader program associated with that particular “main” processing job.

It will also be appreciated that “pilot” processing jobs may typically finish relatively quickly. Thus, performing the check at the point at which individual tasks within a “main” processing job are issued for processing may be particularly efficient since for most tasks for most processing jobs there will be no “pilot” processing jobs currently in flight at the point at which the task is issued for processing (and hence no need for further checking or control once this has been determined).

On the other hand, in the case where it is determined by the task issuing circuit (task iterator) that there is at least one initial “pilot” processing job currently being performed by one (or more) of the processing (shader) cores at the point that a particular task for a particular “main” processing job is issued for processing, this is indicated accordingly when issuing the task to a processing (shader) core for processing, and additional control can then be (and is) performed for the task in question such that any associated “main” shader programs to be executed for the task as part of the “main” processing job are not executed until it can be determined that it is safe to do so, i.e. until any initial “pilot” processing jobs have finished their processing (which as will be explained further below can be appropriately signalled by the processing (shader) cores, e.g. as part of the normal job status signalling).

Thus, in embodiments, the method comprises (the control circuit): when (the task issuing circuit (task iterator) is) issuing a task for a “main” processing job to a respective processing core for processing: determining, based on the tracking, whether any initial “pilot” processing jobs on which the task has a potential dependency are currently being performed by the set of one or more processing cores; and when it is determined that at least one initial “pilot” processing job on which the task has a potential dependency is currently being processed by the set of one or more processing cores at the point at which the task is issued to a respective processing core for processing: issuing the task to the respective processing core for processing concurrently with the at least one initial “pilot” processing job that is being processed by the set of one or more processing cores; and performing at least some processing of the task up to but not including execution of the “main” shader program but waiting at least until the at least one initial “pilot” processing job that was being performed by the set of one or more processing cores concurrently with the task for the “main” processing job has finished its processing before executing the “main” shader program.

When issuing tasks for processing, if any initial “pilot” processing jobs are currently being performed by the set of processing cores, a suitable indication is in embodiments set to ensure that a dependent “main” shader program that is to be executed as part of a subsequent “main” processing job is not executed by any threads for any tasks for the “main” processing job until the initial “pilot” processing jobs have finished (and this control is in embodiments performed across all processing (shader) cores since the task in question that is being controlled may be allocated to a different processing (shader) core to the processing (shader) core that is performing the initial “pilot” processing job).

That is, in embodiments, when it is determined that at least one initial “pilot” processing job on which the task has a potential dependency is currently being processed by the set of one or more processing cores at the point at which the task is issued to a respective processing core for processing, the method comprises indicating that execution of the “main” shader program for the task should be stalled pending the set of one or more processing cores completing processing the at least one initial “pilot” processing job (i.e. pending the set of one or more processing cores completing processing the initial processing job or jobs on which the task has a potential dependency), the indicating causing the processing core to stall execution of the “main” shader program until a signal is received to indicate that the set of one or more processing cores has completed processing the initial “pilot” processing job or jobs on which the task has a potential dependency.

Thus, in embodiments, if at the point that a particular task for a particular “main” processing job is issued for processing there is at least one initial “pilot” processing job currently being performed by one (or more) of the processing (shader) cores, the task is issued to a processing (shader) core for processing, and the processing (shader) core can then (and in embodiments does) start performing some processing for preloading certain state, etc., so long as that processing is not dependent on the results of an initial “pilot” shader program. However, any processing that is dependent on the results of an initial “pilot” shader program, such as loading of any “main” shader program state that is created by an initial “pilot” shader program, as well as execution of the “main” shader program, is stalled until it can be determined that any initial “pilot” processing jobs currently being performed (and on which execution of the “main” shader program may therefore depend) have finished their processing.

In embodiments, the execution of a “main” shader program that is part of a “main” processing job is thus suitably gated (controlled) based on the determination that there is at least one initial “pilot” processing job currently being performed by one (or more) of the processing (shader) cores. Thus, any task associated with the “main” processing job may be processed (only) up to the point of “main” shader program execution, but the “main” shader program execution is in embodiments then gated based on the determination that there is at least one initial “pilot” processing job currently being performed by one (or more) of the processing (shader) cores, such that further processing of the task is effectively stalled.

For example, a suitable barrier may be included within the graphics processing pipeline prior to “main” shader program execution that is operable to gate “main” shader program execution. The barrier may be included within the graphics processing pipeline at any suitable and desired point prior to “main” shader program execution. When a task for a “main” processing job is issued for processing whilst at least one initial “pilot” processing job is currently being performed, this can then be indicated accordingly, e.g. by setting a suitable flag in respect of the task. This indication (flag) when set thus causes the processing of the task to stall at the barrier. On the other hand, if the indication (flag) is not set (i.e. or is cleared), the task can (and in embodiments does) ignore the barrier and further processing of the task including the “main” shader program execution continues accordingly. Thus, as mentioned above, when the at least one initial “pilot” processing job finishes, the task issuing circuit (task iterator) can then signal to the processing (shader) core that there are no initial “pilot” processing jobs currently being performed, and this can cause the indication (flag) to be suitably cleared so that the task can continue past the barrier. Various arrangements would be possible in this regard.

If the “main” shader program execution for a task is gated in this way, the “main” shader program execution can and should accordingly be ungated when it is determined that the initial “pilot” processing job or jobs that were causing the “main” shader program execution to be gated have finished their processing. This can be done in various suitable ways as desired but in embodiments this is done using the reference counter described above. That is, when the (relevant) reference counter decrements to zero, the task issuing circuit (task iterator) in embodiments signals to each processing (shader) core that is performing a dependent processing job that there are no longer any initial “pilot” processing jobs being performed, which signalling then triggers the processing (shader) core to ungate the “main” shader program execution, and allow processing of the task to finish.

Thus, in embodiments, after indicating that execution of the “main” shader program for the task should be stalled pending at least one initial “pilot” processing job on which a task has a potential dependency completing its processing, the method further comprises: the processing core subsequently receiving a signal to indicate that the set of one or more processing cores has completed processing the at least one initial “pilot” processing job (i.e. the initial “pilot” processing job or jobs on which the task has a potential dependency); and in response to such signal the processing core continuing processing the task including executing the “main” shader program.

In this respect, note that the task issuing circuit (task iterator) is generally able to determine which processing (shader) cores are executing a “main” processing job that depends on an initial “pilot” processing job and so this signalling can be, and in embodiments is, done selectively (only) to those processing (shader) cores. In other embodiments, the signalling could be broadcast to all processing (shader) cores. Various arrangements would be possible in this regard.

In the embodiments described, the graphics processor (task issuing circuit (task iterator)) is therefore operable and configured to track whether any processing (shader) cores are currently performing initial “pilot” processing jobs and to use this tracking to suitably gate execution of any “main” shader programs that may depend on the initial “pilot” processing jobs such that any tasks associated with a “main” processing job are stalled prior to execution of the “main” shader program. The graphics processor (task issuing circuit (task iterator)) can then signal to the processing (shader) cores to ungate execution of any “main” shader programs when it is safe to do so. In this way, “main” processing jobs can be preloaded into the processing (shader) cores, as described above, whilst still allowing dependencies on initial “pilot” processing jobs to be enforced across different processing (shader) cores. In this respect, it will be appreciated that in typical cases a “main” processing job will be allocated to a different processing (shader) core than the processing (shader) core that is currently finishing execution of the initial “pilot” processing job. However, embodiments provide an efficient mechanism for handling these dependencies.

Note in this respect that the tracking in embodiments does not specifically track whether the “main” processing job for which tasks are currently being issued for processing actually requires the results of any initial “pilot” processing job that is currently in-flight, and the control (stalling) is in embodiments performed whenever there are any initial “pilot” processing jobs in flight. Thus, in embodiments, it is assumed that execution of a “main” shader program associated with subsequent “main” processing job should always be stalled pending completion of any initial “pilot” processing jobs that are currently in flight (regardless of whether there is an actual processing (data) dependency). This assumption is generally acceptable (and correct) since, in typical cases, because the processing jobs are issued for processing in order, with the workload within a typical processing pass involving a set of one or more initial “pilot” processing jobs followed by a set of one or more “main” processing jobs that use the result of the preceding initial “pilot” processing job(s) (i.e. as part of the same processing pass), it will naturally be the case that when an initial “pilot” processing job is currently in flight at the point at which a “main” processing job is being issued for processing, the “main” processing job will be dependent on the initial “pilot” processing job that is currently in flight.

However, at some point the graphics processor when performing a “main” processing job may encounter within the graphics processor command stream another initial “pilot” processing job (that is to be performed in advance of another subsequent set of “main” processing jobs, i.e. for a subsequent processing pass).

In this respect, it will be appreciated that a processing pass is any suitably defined sequence of processing jobs. In the context of the technology described herein, a given processing pass may thus generally comprise zero or more initial “pilot” processing jobs that are followed by one or more subsequent “main” processing jobs that are dependent on the corresponding initial “pilot” processing jobs within the same processing pass. Typically, the graphics processor will not perform a single processing pass in isolation but will instead be operated to perform a sequence of processing passes. Thus, once a particular (first) processing pass has finished, the graphics processor may start to perform the next (a second) processing pass, which may include its own set of initial “pilot” processing jobs and dependent “main” processing jobs. The second processing pass may or may not be dependent on the first processing pass.

If the second processing pass is dependent on the first processing pass, a relatively stricter (harder) processing barrier may then need to be enforced between the different processing passes. For example, if an initial “pilot” processing job for a second (later) processing pass depends on the results of a first (earlier) processing pass, the initial “pilot” processing job for the second (later) processing pass should not then be executed until the first (earlier) processing pass has finished, and so a stricter (harder) processing barrier may be, and in embodiments is, enforced prior to performing the initial “pilot” processing job for the second (later) processing pass.

On the other hand, so long as the second (later) processing pass is not dependent on the first (earlier) processing pass, it may generally be safe to perform an initial “pilot” processing job for the second (later) processing pass concurrently with finishing any “main” processing jobs for the first (earlier) processing pass (since any “main” processing jobs for the first (earlier) processing pass will generally only depend on the initial “pilot” processing jobs within that first (earlier) processing pass and cannot generally depend on the results of any later-occurring processing passes). However, using the simple tracking mechanism described above, e.g. where a reference counter is used to count any initial “pilot” processing jobs that are currently in flight, if the later-occurring initial “pilot” processing job were issued for processing concurrently with an earlier-occurring “main” processing job, the later-occurring initial “pilot” processing job for a later processing pass could cause a “main” processing job for an earlier processing pass to stall even though there is no possible dependency. It is also possible that the initial “pilot” processing job for the later processing pass could depend on the result of the earlier processing pass. This could potentially result in a possible deadlock situation.

Thus, in embodiments, again, a stricter (harder) processing barrier is in embodiments enforced between any “main” processing jobs for a first (earlier) processing pass and any initial “pilot” processing jobs for a second (later) processing pass. To facilitate this, an additional mechanism is in embodiments provided that marks “main” processing jobs that depend on an earlier initial “pilot” processing job as being dependent. If there is at least one dependent “main” processing job being performed, any new initial “pilot” processing jobs (i.e. for a subsequent processing pass) are then not allowed to launch. This mechanism thus prevents subsequent initial “pilot” processing jobs from causing deadlocks. Further, enforcing such a barrier before subsequent initial “pilot” processing jobs generally has little impact on performance.

Accordingly, in embodiments, a stricter (harder) barrier is still enforced within the command stream between “main” processing jobs and any initial “pilot” processing jobs that occur later in the sequence of processing jobs. Various arrangements would however be possible in this regard.

For example, in embodiments, as mentioned above, the tracking is performed to simply track whether (or not) any initial “pilot” shader programs are currently being executed, without attempting to explicitly track which processing pass the initial “pilot” shader programs relate to (and in this case a harder (stricter) barrier may be enforced before issuing any further initial “pilot” shader programs (i.e. for the next processing pass) to ensure that any initial “pilot” shader programs implicitly relate to the current processing pass).

However, it would also be possible to perform the tracking for individual processing passes. That is, the tracking may explicitly track whether any initial “pilot” processing jobs are currently being processed by the set of one or more processing cores for the current processing pass (with separate tracking potentially being performed for different processing passes, e.g. using a suitable processing pass (e.g. age) identifier that indicates which processing pass a particular set of initial “pilot” and subsequent “main” processing jobs relate to). Thus, in embodiments, the tracking whether any initial “pilot” processing jobs are currently being processed by the set of one or more processing cores is performed on a per-processing pass basis, such that it is tracked for individual processing passes whether or not any initial “pilot” processing jobs are currently being processed by the set of one or more processing cores for that (particular) processing pass.

In that case, it may accordingly be possible to track which initial “pilot” processing job a particular “main” processing job depends on, and control processing of the “main” processing job based only on the tracking of the particular initial “pilot” processing job (or jobs) on which it depends. In that case, e.g. so long as the later “pilot” processing job does not itself depend on an earlier processing pass (in which case a strict (hard) processing barrier should in embodiments still be enforced) it may then be possible to perform an initial “pilot” processing job for a second, later processing pass concurrently with processing of a “main” processing job for a first, earlier processing pass, for example. Thus, in embodiments, the controlling processing of the task for the “main” processing job may comprise controlling processing of the task based on the tracking whether or not any initial “pilot” processing jobs are currently being processed by the set of one or more processing cores for the same processing pass including the “main” processing job (whereas initial “pilot” processing jobs and “main” processing jobs for different processing passes may be performed concurrently).

An initial “pilot” processing job may also depend on a previous initial “pilot” processing job within the same or a previous processing pass. In that case, it may be necessary to enforce stricter (harder) processing barriers within the command stream between different initial “pilot” processing jobs. In embodiments, therefore, a stricter (harder) barrier is enforced before any new initial “pilot” processing job is issued for processing (such that there is in embodiments a barrier between a “main” processing job for an earlier processing pass and an initial “pilot” processing job for a later processing pass, and in embodiments also a barrier between different initial “pilot” processing jobs within the same processing pass as these could in principle also depend on each other) (in this case the number of initial “pilot” processing jobs in flight may then only be zero or one). Again, this does not introduce significant latency since the initial “pilot” processing jobs are typically relatively quick to finish (compared to the subsequent “main” processing jobs).

However, various arrangements would be possible in this regard and different initial “pilot” processing jobs (for different processing passes) could also be performed concurrently, e.g. so long as a suitable mechanism was provided to enforce any potential processing (data) dependencies that may exist.

Thus, the technology described herein avoids a strict (hard) processing barrier between initial “pilot” processing jobs and dependent “main” processing jobs (although a stricter (harder) processing barrier is in embodiments still enforced before issuing any new initial “pilot” processing jobs, as described above). The graphics processor then tracks whether (or not) any initial “pilot” processing jobs are currently being performed by its set of one or more processing (shader) cores and controls processing of dependent “main” processing jobs based on this tracking to enforce any data (processing) dependencies to initial “pilot” processing jobs as needed.

Thus, the technology described herein may generally comprise issuing a “main” processing job to the set of one or more processing cores for processing concurrently with at least one initial “pilot” processing job; and controlling processing of the “main” processing job within the set of one or more processing cores such that the “main” shader program for the “main” processing job is not executed until all of its corresponding initial “pilot” shader programs have been executed.

The effect and benefit of all this therefore is to allow at least some processing for subsequent “main” processing jobs to be performed concurrently with their corresponding initial “pilot” processing jobs, thus moving the processing barrier between “main” and initial “pilot” processing jobs from the command stream into the graphics processor processing (shader) cores, with any data (processing) dependencies between “main” and initial “pilot” processing jobs then being managed by the graphics processor (hardware) to ensure a safe (artefact-free) graphics processor operation. As explained above, this can then increase processing (shader) core utilisation and also reduce latency associated with such initial “pilot” processing jobs.

In this regard, an additional effect and benefit of the technology described herein is that in many cases, because initial “pilot” processing jobs typically finish relatively quickly, any possible data (processing) dependencies between initial “pilot” and subsequent “main” processing jobs will already have naturally resolved by the time that the “main” shader program is to be executed. That is, in many cases, by the time the frontend processing for a task for a “main” processing job that is being performed in parallel with execution of a “pilot” shader program as part of an initial “pilot” processing job has completed, any “pilot” shader program that was being executed concurrently with the frontend processing will also have completed its execution, such that the “main” shader program can then be executed immediately. That is, in many cases, there will be no need to stall the execution of the “main” shader program since by the time that the “main” shader program is ready to be executed, the initial “pilot” shader program may, and often will, have completed. Being able to preload the “main” processing job can therefore provide a significant performance improvement as in many typical cases the “main” shader program can be executed in respect of a task that is to be processed as part of a “main” processing job immediately, without having to stall (control) the processing of the “main” shader program as it is will often by the case that there will be no outstanding dependencies to “pilot” shader programs by the time the frontend processing for the task has completed.

(Similarly, it may be possible by performing the frontend processing to cull certain tasks without having to execute the “main” shader program at all and by allowing the frontend processing to be performed concurrently with initial “pilot” shader program execution this can be determined relatively earlier.)

Thus, the technology described herein provides a mechanism to ensure that execution of “main” shader programs can be stalled when it is necessary to do so to allow corresponding initial “pilot” shader programs to finish executing, thus ensuring a safe (correct) graphics processing operation, but the present Applicants have recognised that in typical graphics processing applications in many cases it may not actually be required to stall “main” shader program execution (and in such cases it may rather simply be necessary to check whether any initial “pilot” shader programs are currently executing, but if not, the “main” shader program can then executed as normal without having to further control (e.g. stall) its processing).

The technology described herein may therefore provide various benefits compared to other approaches.

As mentioned above, the technology described herein relates to the situation where initial “pilot” shader programs are used to execute certain expressions within an original shader program. The use of such “pilot” shader programs is described, for example, in U.S. Pat. No. 9,189,881, assigned to Arm Limited, the entire content of which is incorporated herein by reference.

Thus, an original shader program is, in effect, split into an initial “pilot” shader program and a corresponding, subsequent “main” shader program that uses the results of the initial “pilot” shader program. The “main” shader program may thus contain load instructions which point to output values that have been generated and stored by executing the initial pilot shader program.

Thus, for an initial “pilot” shader program that is to be executed as part of a respective initial “pilot” processing job, embodiments may further comprise subsequently executing a subsequent “main” shader program corresponding to the initial pilot shader program that contains load instructions which point to output values generated and stored for the constant program expressions by executing the initial pilot shader program. Subsequently executing the subsequent shader program may comprise, in response to the load instructions of the subsequent shader program that point to output values generated and stored for the constant program expressions by executing the initial pilot shader program, loading the output values generated and stored for the constant program expressions by executing the initial pilot shader program for processing by the subsequent shader program.

Subsequently executing a subsequent shader program corresponding to an initial pilot shader program of the set of initial pilot shader programs may be performed in any desired and suitable way. For example, subsequently executing a subsequent shader program corresponding to an initial pilot shader program of the set of initial pilot shader programs may comprise executing the subsequent shader program on the (same) graphics processing pipeline.

In general there may be any number of initial “pilot” processing jobs that are defined for a particular processing pass (including zero). That is, a processing pass may generally include zero or more initial “pilot” processing jobs and any number of “main” processing jobs. The situation where there are zero initial “pilot” processing jobs can still be handled efficiently by the tracking of the technology described herein (as in this case the tracking will always determine that there are no initial “pilot” processing jobs being performed such that no additional control (e.g. stalling) needs to be performed). Alternatively, if it can be identified earlier that there are no initial “pilot” processing jobs in a particular sequence of processing jobs to be performed, some or all of the technology described herein could be selectively disabled. That is, in some embodiments, the operation according to the technology described herein may be selectively triggered by the graphics processor (command processing unit (command stream frontend/job manager (circuit))) identifying that a sequence of processing jobs includes one or more initial “pilot” processing jobs. Various arrangements are possible in this regard.)

Subject to the particular requirements of the technology described herein, the initial “pilot” shader programs may be generated and configured in any suitable and desired manner.

For instance, creating an initial pilot shader program of the set of initial pilot shader programs may comprise identifying, in an original shader program, constant program expressions. Embodiments may then comprise creating the initial pilot shader program of the set of initial pilot shader programs, wherein the initial pilot shader program contains instructions for executing the constant program expressions.

Embodiments may further comprise creating a subsequent shader program that corresponds to an initial pilot shader program of the set of initial pilot shader programs that contains load instructions which point to output values to be generated and stored for the constant program expressions by executing the initial pilot shader program. Creating a subsequent shader program that corresponds to an initial pilot shader program of the set of initial pilot shader programs may comprise removing instructions for executing constant program expressions from an original shader program and replacing the instructions for executing the constant program expressions with the load instructions that point to the output values to be generated and stored for the constant program expressions by executing the initial pilot shader program.

The identification of constant program expressions in an original shader program, and the corresponding creation of an initial pilot shader program, and the corresponding creation of a subsequent shader program, can be performed as desired. For example, the identification of constant program expressions in an original shader program can identify those expressions in any suitable form in the, e.g., compilation process, for example as “expressions” in the high level shader language, or as a corresponding set of instructions in the target code for a graphics processing pipeline, or as an appropriate set of “operations” in some intermediate representation of the shader program.

Thus, the identification of constant program expressions may be carried out on or using an intermediate representation of an original shader program. Similarly, an initial pilot shader program containing instructions for executing the constant program expressions may be created in the form of a higher level shader language program that is then subsequently converted to the necessary instructions for execution, e.g. on a graphics processing pipeline, or may be created directly as a set of instructions to be executed, e.g. on a graphics processing pipeline, or may be created in the form of some intermediate representation that is then converted to the instructions for execution, e.g. on a graphics processing pipeline. Thus, the creation of an initial pilot shader program may create that initial pilot shader program in the form of an intermediate representation that will then be translated to binary code “instructions” for execution, e.g. on a graphics processing pipeline.

The identification of constant program expressions in an original shader program, and the corresponding creation of an initial pilot shader program, and the corresponding creation of a subsequent shader program, can be performed in and by any suitable stage or component of the graphics processing system. For example, a compiler for the shader or shaders in question may perform this operation.

As discussed above, an original shader program to be executed by a given programmable shading stage will normally be provided by the application that requires the graphics processing using a high-level shader programming language, such as GLSL, HLSL, OpenCL, etc. This shader program is then translated by a shader language compiler to binary code for a target graphics processing pipeline. Thus in embodiments, the shader compiler may identify constant expressions in the original shader program in question, prevent the instructions for executing those constant program expressions from being emitted into a target graphics processing pipeline binary code, create instead a separate binary code that contains hardware instructions for the constant program expressions only, and then provide the relevant binary code to a graphics processing pipeline for execution.

The constant program expressions can comprise any desired and suitable constant program expressions, for example that operate on constant inputs. The constant inputs can comprise any desired and suitable inputs, such as inputs that cannot vary and/or that will not vary, e.g. between draw calls. The constant inputs may also or instead comprise inputs that could vary, e.g. between draw calls, but that are determined to be constant, e.g. for one or more particular draw calls, at run time (i.e. “run time constant inputs”).

The output values of an initial pilot shader program can be stored as desired. The output values may be stored in such a manner that those values can be loaded and treated as input values by a subsequent shader program when the substituted load instructions in that subsequent shader program are executed. Thus, the output of an initial pilot shader program may be a memory area storing input values for a subsequent shader program. This memory area may be any storage accessible in a shader program via graphics processing pipeline instructions (such as main memory, stack memory, a tile buffer, uniform memory, and so on). This memory area may, e.g., be addressed directly, be remapped as a colour buffer (render target), or be remapped as an initial pilot shader program's stack area.

The output of an initial pilot shader program may be mapped as (written to) a colour buffer (render target), and the output colour buffer of that initial pilot shader program is then mapped to the input uniform of the corresponding subsequent shader program (i.e. load instructions in a subsequent shader program may point to and instruct loads from an output colour buffer that will be generated by an initial pilot shader program).

Various arrangements would be possible in this regard.

The technology described herein may generally find application in any suitable graphics processing system.

Subject to the particular requirements of the technology described herein, the graphics processor when operating according to the technology described herein can be used for all forms of output that a graphics processing pipeline may be used to generate, such as frames for display, render-to-texture outputs, etc., The technology described herein can generally be used for both graphics and non-graphics (e.g. “compute”) workloads as well as mixed workloads.

Thus, the processing jobs that are being performed may generally comprise any suitable and desired processing jobs. This may include rendering jobs in which the shader programs include fragment shader programs, for example. The technology described herein may find particular utility in this context since the fragment frontend processing stages in a graphics processing pipeline can often be relatively significant when performing a fragment rendering job (e.g. compared to a “compute” job where there may be relatively little frontend processing). Thus, the ability to preload such fragment jobs into the set of processing (shader) cores may provide a significant reduction in latency. However, in general the technology described herein may find utility for any type of processing jobs (including “compute” jobs) that may be performed by a graphics processor and where initial “pilot” shader programs may be utilised.

The technology described herein relates in embodiments to tile-based rendering systems in which a render output (e.g. a frame) is subdivided into plural rendering tiles for the purposes of rendering. In that case each rendering tile may and in embodiments does correspond to a respective sub-region of the overall render output (e.g. frame) that is being generated. For example, a rendering tile may correspond to a rectangular (e.g. square) sub-region of the overall render output.

In embodiments the rendering is performed using rasterisation. However, it will be appreciated that the technology described herein is not necessarily limited to rasterisation-based rendering and may generally be used for other types of rendering, including ray tracing or hybrid ray tracing arrangements.

In some embodiments, the graphics processing system comprises, and/or is in communication with, one or more memories and/or memory devices that store the data described herein, and/or store software for performing the processes described herein. The graphics processing system may also be in communication with a host microprocessor, and/or with a display for displaying images based on the data generated by the graphics processing system.

In an embodiment, the various functions of the technology described herein are carried out on a single graphics processing platform that generates and outputs the rendered data that is, e.g., written to a frame buffer for a display device.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, and pipelines of the technology described herein may comprise a suitable processor or processors, controller or controllers, functional units, circuits/circuitry, processing logic, microprocessor arrangements, etc., that are operable to perform the various functions, etc., such as appropriately configured dedicated hardware elements or processing circuits/circuitry, and/or programmable hardware elements or processing circuits/circuitry that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuits/circuitry, if desired.

Thus the technology described herein extends to a graphics processor and to a graphics processing platform including the apparatus of or operated in accordance with any one or more of the embodiments of the technology described herein described herein. Subject to any hardware necessary to carry out the specific functions discussed above, such a graphics processor can otherwise include any one or more or all of the usual functional units, etc., that graphics processors include.

It will also be appreciated by those skilled in the art that all of the described embodiments of the technology described herein can, and in embodiments do, include, as appropriate, any one or more or all of the optional features described herein.

The methods in accordance with the technology described herein may be implemented at least partially using software e.g. computer programs. It will thus be seen that when viewed from further embodiments the technology described herein comprises computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a graphics processor, renderer or microprocessor system comprising a data processor causes in conjunction with said data processor said processor, renderer or system to carry out the steps of the methods of the technology described herein. Such a computer software carrier could be a physical storage medium such as a ROM chip, RAM, flash memory, CD ROM or disk, or could be a signal such as an electronic signal over wires, an optical signal or a radio signal such as to a satellite or the like.

It will further be appreciated that not all steps of the methods of the technology described herein need be carried out by computer software and thus a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible medium, such as a non-transitory computer readable medium, for example, diskette, CD-ROM, ROM, RAM, flash memory or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

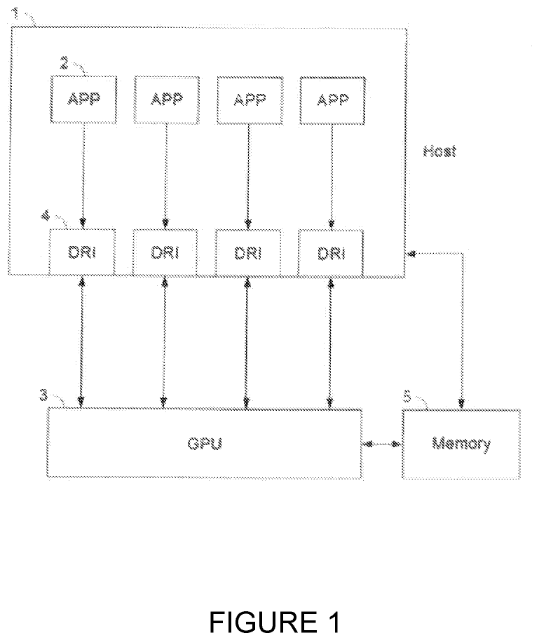

FIG. 1 shows a typical computer graphics processing system. An application 2, such as a game, executing on a host processor (CPU) 1 will require graphics processing operations to be performed by an associated graphics processing unit (GPU) (graphics processor) 3 that executes a graphics processing pipeline. To do this, the application will generate API (Application Programming Interface) calls that are interpreted by a driver 4 for the graphics processor 3 that is running on the host processor 1 to generate appropriate commands to the graphics processor 3 to generate graphics output required by the application 2. To facilitate this, a set of “commands” will be provided to the graphics processor 3 in response to commands from the application 2 running on the host system 1 for graphics output (e.g. to generate a frame to be displayed).

As shown in FIG. 1, the graphics processing system will also include an appropriate memory system 5 for use by the host CPU 1 and graphics processor 3.

When a computer graphics image is to be displayed, it is usually first defined as a series of primitives (polygons), which primitives are then divided (rasterised) into graphics fragments for graphics rendering in turn. During a normal graphics rendering operation, the renderer will modify the (e.g.) colour (red, green and blue, RGB) and transparency (alpha, a) data associated with each fragment so that the fragments can be displayed correctly. Once the fragments have fully traversed the renderer, their associated data values are then stored in memory, ready for output, e.g. for display.

In the present embodiments, graphics processing is carried out in a pipelined fashion, with one or more pipeline stages operating on the data to generate the final output, e.g. frame that is displayed.

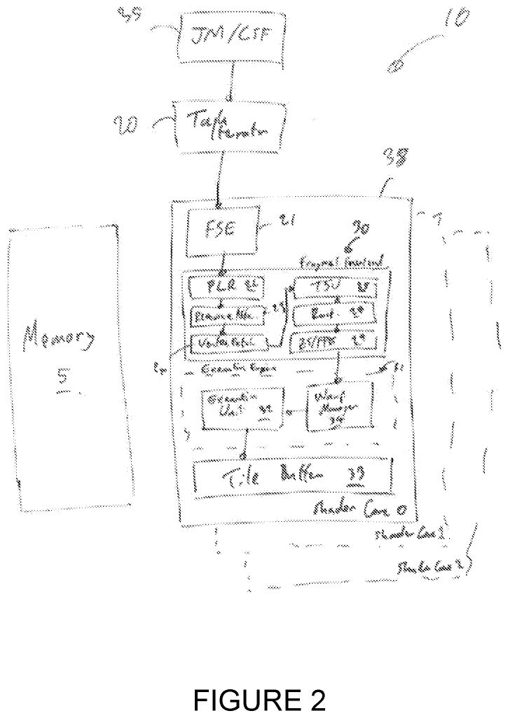

FIG. 2 shows an exemplary graphics processing pipeline 10 that may be executed by the graphics processor 3 according to an embodiment. The graphics processing pipeline 10 shown in FIG. 2 is a “tile-based” rendering system, and will thus produce tiles of an output data array, such as an output frame to be generated. Thus, an example will now be described in the context of “tile-based” rendering. In FIG. 2, the rendering is performed using rasterisation, as will be explained further below. However, it will be appreciated that the technology described herein is not necessarily limited to rasterisation-based rendering and may generally be used for other types of rendering, including ray tracing or hybrid ray tracing arrangements. Likewise, the technology described herein is not necessarily limited to tile-based rendering and may also be used for other types of rendering including immediate-mode rendering arrangements.

The output data array may typically be an output frame intended for display on a display device, such as a screen or printer, but may also, for example, comprise a “render to texture” output of the graphics processor, or other suitable arrangement.

FIG. 2 shows the main elements and pipeline stages of the graphics processing pipeline 10 according to the present embodiments. As will be appreciated by those skilled in the art, there may be other elements of the graphics processing pipeline that are not illustrated in FIG. 2.

It should also be noted here that FIG. 2 is only schematic, and that, for example, in practice the shown functional units and pipeline stages may share significant hardware circuits, even though they are shown schematically as separate stages in FIG. 2. Equally, some of the elements depicted in FIG. 2 need not be provided, and FIG. 2 merely shows one example of a graphics processing pipeline 10. It will also be appreciated that each of the stages, elements and units, etc., of the graphics processing pipeline as shown in FIG. 2 may be implemented as desired and will accordingly comprise, e.g., appropriate circuits and/or processing logic, etc., for performing the necessary operation and functions.

The graphics processing pipeline as illustrated in FIG. 2 will be executed on and implemented by the graphics processing unit (GPU) (graphics processor) 3, which will accordingly include the necessary functional units, processing circuits, etc., operable to execute the graphics processing pipeline stages.

(It will be appreciated that the graphics processing unit (GPU) (graphics processor) 3 may, and generally will, include various other functional units, processing circuits, etc., not shown in FIG. 2. This may include various functional units, processing circuits, etc., that are operable to execute non-graphics processing work. For example, in addition to graphics processing work, the graphics processing unit (GPU) (graphics processor) 3 may also be operable to perform general-purpose “compute” operations, and may therefore also include various functional units, processing circuits, etc., operable to execute such non-graphics processing work. Thus, although not shown in FIG. 2, the shader cores 38 may for example, in addition to the fragment shader endpoint 21 that will be described below, also comprise a suitable “compute” shader endpoint that is operable and configured to issue compute tasks to the execution engine 31 for processing. The shader cores 38 may, for example, also contain other suitable endpoints, as desired, that are operable and configured to issue other types of tasks to the execution engine 31 for processing. Various arrangements would be possible in this regard.)

FIG. 2 shows the stages of the graphics processing pipeline after a tiler (not shown) of the graphics processor has prepared the primitive lists (as the graphics processing pipeline 10 is a tile-based graphics processing pipeline).

(The tiler in effect determines which primitives need to be processed for different regions of the output. In the present embodiments, these regions may, e.g., represent a tile into which the overall output has been divided into for processing purposes, or a set of multiple such tiles. To do this, the tiler compares the location of each primitive to be processed with the positions of the regions, and adds the primitive to a respective primitive list for each region that it determines the primitive could (potentially) fall within. Any suitable and desired technique for sorting and binning primitives into tile lists, such as exact binning, or bounding box binning or anything in between, can be used for the tiling process.)

Once the tiler has completed the preparation of the primitive lists (lists of primitives to be processed for each region), then each tile can be rendered with reference to its associated primitive list(s).

To do this, each tile is processed by the graphics processing pipeline stages shown in FIG. 2.

A fragment task iterator 20 is thus provided that schedules processing work to the graphics processing pipeline 10.

The fragment task iterator 20 may thus schedule the graphics processing pipeline to generate a first output, which may, e.g. be a frame to display. In the present embodiments, wherein the graphics processing pipeline 10 is a tile-based system, in which the output has been divided into a plurality of rendering tiles, the graphics processing pipeline 10 iterates over the set of tiles for the first output, rendering each tile in turn.

As shown in FIG. 2, the graphics processor 3 includes an overall controller in the form of a job manager circuit (a command stream frontend circuit) 35, that is operable to receive tasks for the graphic processor 3 for processing from the host processor 1, which job manager 35 can then communicate the relevant jobs to respective elements of the graphics processor and graphics processing pipeline 10, via an appropriate bus/interconnect.

Thus, as shown in FIG. 2, the job manager 35 will, inter alia, issue fragment processing tasks to the fragment task iterator 20 for the fragment task iterator 20 to then schedule the appropriate fragment shading tasks to and onto the graphics processing pipeline 10.

In the present embodiments, the graphics processing pipeline 10 is implemented by means of an appropriate processing (“shader”) core. In particular, as shown in FIG. 2, the graphics processor 3 includes a plurality of “shader” cores that are each configured to implement a respective parallel instance of the graphics processing pipeline 10. Thus, the fragment task iterator 20 is operable to and configured to issue tasks to different ones of the of shader cores 38, e.g. to try to balance processing work between the different shader cores.

(Although not shown in FIG. 2, there may be various other task iterators that control the issuing of “compute” or other tasks, etc.)

As will be explained further below, each “shader” core includes a fragment “frontend” 30 that may be, and typically is, implemented in essentially fixed-function hardware, and that performs set up for the fragment shader programs, as well as a programmable stage (execution engine 31) that executes the fragment shader programs to perform the actual rendering.

When a rendering task (i.e. tile) is allocated to a given shader core 38 for processing, the tile is then processed (rendered) accordingly, i.e. by the graphics processing pipeline 10.

For a given tile that is being processed, a primitive list reader (or ‘polygon list reader’) 22 thus identifies a sequence of primitives to be processed for that tile (the primitives that are listed in the primitive list(s) for that tile), and an ordered sequence of primitives for the tile is then issued into the graphics processing pipeline 10 for processing.

A resource allocator 23 then configures and manages the allocation of memory space for the depth (Z), colour, etc., buffers 33 for the tile of the output that is being generated. These buffers may, e.g., be provided as part of RAM that is located on (local to) the graphics processing pipeline (chip).

A vertex loader 24 then loads in the vertices for the primitives, which are then passed into a primitive set-up unit (or ‘triangle set-up unit’) 25 that operates to determine, from the vertices for the primitives, edge information representing the primitive edges.

The edge information for the re-ordered primitives is then passed to the rasteriser 27, which rasterises the primitives into a set of one or more sampling positions and generates from the primitives individual graphics fragments having appropriate positions (representing appropriate sampling positions) for rendering the primitive.

The fragments generated by the rasteriser 27 are then sent onwards to the rest of the pipeline for processing.

For instance, in the present embodiments, the fragments generated by the rasteriser 27 are subject to (early) depth (Z)/stencil testing 29, to see if any fragments can be discarded (culled) at this stage. To do this, the Z/stencil testing stage 29 compares the depth values of (associated with) fragments issuing from the rasteriser 27 with the depth values of fragments that have already been rendered (these depth values are stored in a depth (Z) buffer that is part of the tile buffer 33) to determine whether the new fragments will be occluded by fragments that have already been rendered (or not). At the same time, an early stencil test is carried out.

Fragments that pass the fragment early Z and stencil test stage 29 may then be subject to further culling operations, such as a ‘forward pixel kill’ test, e.g. as described in United States Patent Application Publication No. 2019/0088009 (Arm Limited), before the remaining fragments are then passed to a fragment shading stage, in the form of an execution engine 31, for rendering.

The processing stages including the primitive list reader (or ‘polygon list reader’) 22 up to the (early) depth (Z)/stencil testing 29 thus together constitute a fragment “frontend” 30 that serves to set up the required data for the fragment processing operations to be performed by the execution engine 31.

The execution engine 31 then performs the appropriate fragment processing operations on the fragments that pass the early Z and stencil tests, so as to process the fragments to generate the appropriate rendered fragment data.

This fragment processing may include any suitable and desired fragment shading processes, such as executing fragment shader programs for the fragments, applying textures to the fragments, applying fogging or other operations to the fragments, etc., to generate the appropriate rendered fragment data.

Thus, as shown in FIG. 2, in the present embodiment, the execution engine 31 includes a programmable execution unit (engine) 32 operable to execute fragment shader programs for respective execution threads (where each thread corresponds to one work item, e.g. an individual fragment, for the output being generated) to perform the required fragment shading operations to thereby generate rendered fragment data. The execution unit 32 can operate in any suitable and desired manner in this regard and comprise any suitable and desired processing circuits, etc.

In the present embodiments, the execution threads may be arranged into “groups” or “bundles” of threads, where the threads of one group are run in lockstep, one instruction at a time, i.e. each thread in the group executes the same single instruction before moving onto the next instruction. In this way, it is possible to share instruction fetch and scheduling resources between all the threads in a group. Such thread groups may also be referred to as “sub-groups”, “warps” and “wavefronts”. For convenience the term thread group will be used herein, but this is intended to encompass all equivalent terms and arrangements, unless otherwise indicated.

FIG. 2 accordingly also shows a thread group controller, in the form of a warp manager 34, that is configured to control the allocation of work items (e.g. fragments) to respective thread groups for the fragment shading operations to be performed by the programmable execution unit 32, and the issuing of thread groups to the programmable execution unit 32 for the execution of the fragment shading programs by respective thread groups.

As shown in FIG. 2, the programmable execution unit 32 is also in communication with the memory 5.

Once the fragment shading is complete, the output rendered (shaded) fragment data is written to the tile buffer 33 from where it can, for example, be output to a frame buffer (e.g. in the memory 5) for display. The depth value for an output fragment is also written appropriately to a Z-buffer within the tile buffer 33. (The tile buffer stores colour and depth buffers that store an appropriate colour, etc., or Z-value, respectively, for each sampling position that the buffers represent (in essence for each sampling position of a rendering tile that is being processed).) These buffers store an array of fragment data that represents part (a tile) of the overall output (e.g. image to be displayed), with respective sets of sample values in the buffers corresponding to respective pixels of the overall output (e.g. each 2×2 set of sample values may correspond to an output pixel, where 4× multisampling is being used).

As mentioned above, the tile buffer 33 is normally provided as part of RAM that is located on (local to) the graphics processor.

Once a tile for the output has been processed, the data from the tile buffer(s) may thus be written back to an external memory output buffer, such as a frame buffer of a display device (not shown), e.g. in the memory 5. (The display device could comprise, e.g., a display comprising an array of pixels, such as a computer monitor or a printer.)

The next tile is then processed, and so on, until sufficient tiles have been processed to generate the entire output (e.g. frame (image) to be displayed). The process is then repeated for the next output (e.g. frame) and so on.

As described above in relation FIG. 2, the graphics processing pipeline 10 includes a programmable processing or “shader” stage in the form of the fragment shading stage (although various other “shader” stages such as a vertex shader, hull shader, domain shader, geometry shader, etc., may also generally be present) for execution of respective shader programs that have one or more input variables and generate sets of output variables and that are provided by the application. To do this, the application 2 provides the shader programs implemented using a high-level shader programming language, such as GLSL, HLSL, OpenCL, etc. These shader programs are then translated by a shader language compiler to binary code for the target graphics processing pipeline 10. This may include, for instance, the creation of one or more intermediate representations of the program within the compiler. (The compiler may, e.g., be part of the driver 4, with there being a special API call to cause the compiler to run. The compiler execution can thus be seen as being part of the draw call preparation done by the driver in response to API calls generated by an application).

Shader programs typically contain constant expressions (constructions expressed in a shader language that have constant inputs). These constant expressions can be classified into two types: compile time constant expressions (defined in language specifications (such as literal values, an arithmetic operator with constant arguments, etc.)): and run time constant expressions. Run time constant expressions are not defined anywhere, but can be seen as a global variable that is known to be constant for a particular draw call (i.e. for all pipeline stages used within the draw call) and all operations in a shader program that depend only on the global variable in question. In the case of run time constant expressions, the value of the variable is not known by the compiler at compile time. An example of such a variable is an expression qualified as “uniform” in a GLSL shader program.

Examples of expressions that operate on run time constant inputs comprise: global variables that are known to be constant for a particular draw call; constant expressions as defined in a shader language specification; shader language expressions formed by an operator on operands that are all run time constant expressions; and shader language constructions that are defined in the language specification as constant expressions and for which all the operands are run time constants.

The present embodiments relate particularly to the situation in which the graphics processor is performing a processing pass including one or more initial processing jobs, wherein an initial processing job executes a respective initial shader program that is to be executed in advance of a corresponding “main” shader program that will be executed for a separate “main” processing job within the same processing pass.

For instance, such run time constant expressions in shader programs may be identified and extracted from the original shader program such that the run time constant expressions are instead executed in an initial shader program (a “pilot” shader program).

To do this, the shader compiler identifies such run time constant expressions in a given shader program to be executed, removes such expressions from the original shader program (prevents such expressions from being emitted into the target GPU code), and creates a separate shader program (binary code) that contains hardware instructions only for the identified expressions together with metadata for those expressions to thereby create a “pilot” shader program that can be executed in advance of the main shader program. The metadata includes the information necessary to execute the “pilot” shader program on the graphics processing pipeline and to be able later to fetch the result(s) of the pilot shader program. Thus, the metadata may comprise, for example, one or more of the memory layout for the inputs, the memory layout for the outputs, and/or a description of where the outputs are written. The metadata can be different for different architectures/implementations.

The compiler also substitutes the original run time constant expressions in the main shader program with appropriate load instructions pointing to where the output results from the pilot shader program will be stored.

This is done for some and in an embodiment all of the shader programs to be executed for a given desired graphics processing output.

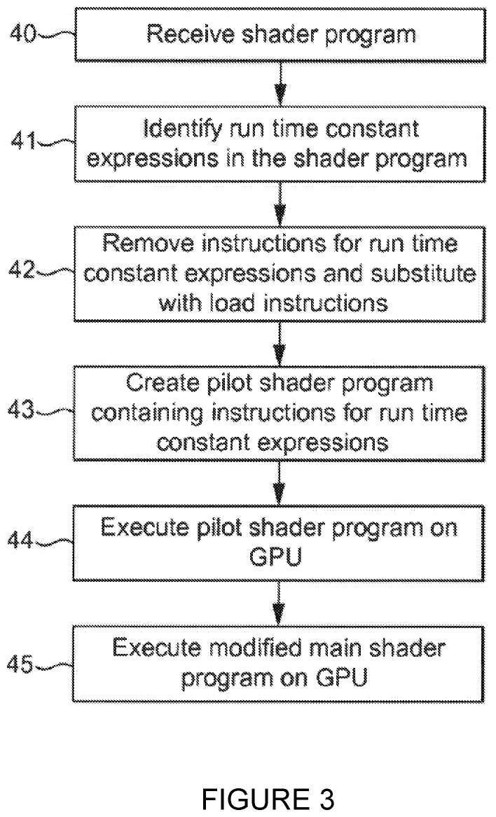

FIG. 3 illustrates this process. As shown in FIG. 3, the shader compiler will receive a shader program in a high level programming language to be compiled (step 40), and first identify any run time constant expressions in the shader program (step 41). It will then remove instructions emitted for such expressions from the original shader program, and substitute them in the original main shader program with appropriate load instructions pointing to where the output results from the pilot shader program will be stored (step 42). The shader compiler then creates a separate shader program (binary code) that contains hardware instructions only for the identified run-time constant expressions together with any necessary metadata for those instructions to thereby create a “pilot” shader program (step 43) that can be executed in advance of the main shader program.

In the present embodiment, the compiler configures the pilot shader programs such that they output to a colour buffer (render target) in the tile buffer 33. The corresponding load instructions substituted into the main shader program then map to this colour buffer so that the main shader program will use the results of the pilot shader program as its inputs (where required). Other arrangements for the output of the pilot shader, such as remapping the pilot shader's stack area, can be used, if desired. In general any storage accessible in a shader program via graphics processing pipeline instructions (such as main memory, stack memory, a tile buffer, uniform memory, and so on) can be used for the output of the pilot shader program.

Once the pilot and main shader programs for execution have been compiled, the pilot shader program is executed on the graphics processing pipeline 10 (step 44), followed by the modified main shader program (step 45). To do this, the driver 4 on the host processor 1 for the graphics processing unit 3 initialises the data required by the draw calls, creates a dependency chain of necessary jobs for the draw call stages and pilot shaders, and then sends the jobs to the graphics processing pipeline 10 for execution.

In some more traditional graphics processor operation, the driver 4 then ensures that the created pilot shader programs are executed after the relevant draw call's data has been initialised, but before the corresponding draw call stage is activated (i.e. before the main shader program is executed). This then ensures that the pilot shader is executed on the graphics processing unit 3 so that all its calculations are done before the main shader program is invoked. Thus, in some more traditional graphics processor operation, these dependencies are managed by including an explicit strict (hard) barrier within the graphics processor command stream, e.g. by inserting a suitable ‘wait’ command between the ‘run_fragment pilot’ and main ‘run_fragment’ commands, e.g. as follows;
run_fragment pilot
wait for pilots to finish
run_fragment
. . .

This more traditional graphics processor operation ensures that all pilot shader programs finish before any main shader programs that may use the result of the pilot shader program are executed. However, pilot shader programs can often take a few thousand cycles to execute, and typically do not fully utilise the shader cores. Therefore, because of the strict (hard) barrier within the graphics processor command stream, the job manager circuit (a command stream frontend circuit) 35 cannot start to issue rendering tasks for the next ‘run_fragment’ rendering job for processing until the pilot shader programs on which the rendering job potentially depends have finished execution, it is often the case that the pilot shader programs may only be executing on a single core and so all of the other shader cores may sit idle for a number of cycles waiting for a single core to finish executing the pilot shader programs.

According to the present embodiments, therefore, the job manager circuit (command stream frontend circuit) 35 is permitted to issue dependent main processing jobs to respective shader cores 38 for processing concurrently with their respective pilot jobs, such that the strict (hard) barrier between pilot jobs and their dependent main processing jobs is removed. This then effectively allows the graphics processor to run ahead of its current command stream execution and start performing at least some processing of dependent main processing jobs without necessarily waiting for any associated pilot shader programs to have finished their execution. This can accordingly increase average shader core utilisation and also help to reduce latency by effectively preloading jobs into the task iterator 20 and shader cores. In contrast, in the more traditional graphics processor operation described above the need to enforce a strict (hard) barrier within the graphics processor command stream may mean that the task iterator 20 and/or shader core 38 execution stalls pending completion of a pilot job.

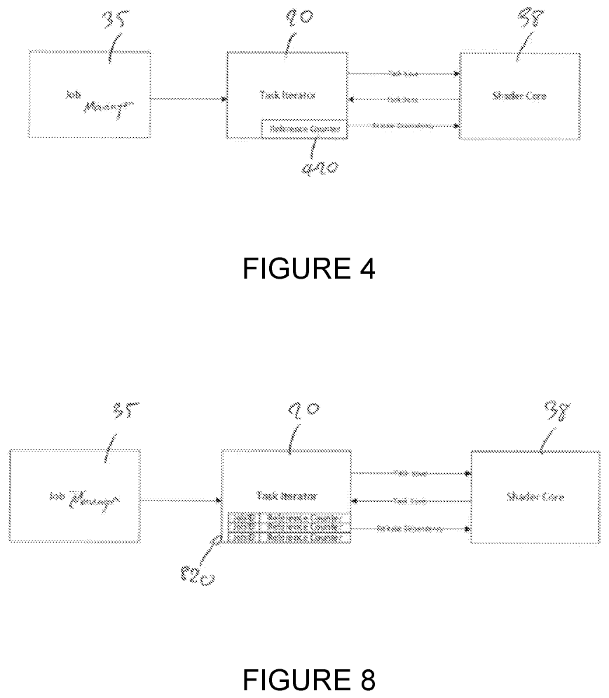

Any dependencies between pilot and main processing jobs within the same processing pass can then be (and in the present embodiments are) enforced, as required, within the shader cores 38, e.g. rather than enforcing a strict (hard) processing barrier within the graphics processor stream In particular, to facilitate managing these dependencies, as shown in FIG. 4, the task iterator 20 is operable and configured to maintain a reference counter 420 (or set of reference counters 820, as will be explained further below in relation to FIG. 8) that tracks whether any pilot jobs are currently in-flight. This tracking can then be used to control execution of any potentially dependent main processing jobs within the shader cores 38, e.g. to ensure that any main shader program is not executed until its corresponding pilot shader program have finished.

The overall control operation according to the present embodiments will now be described.

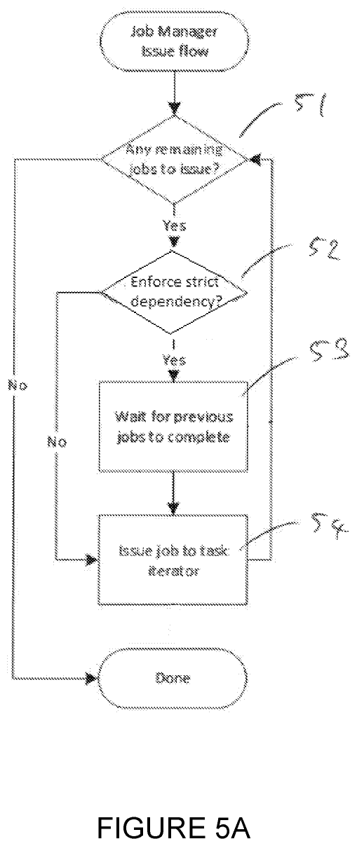

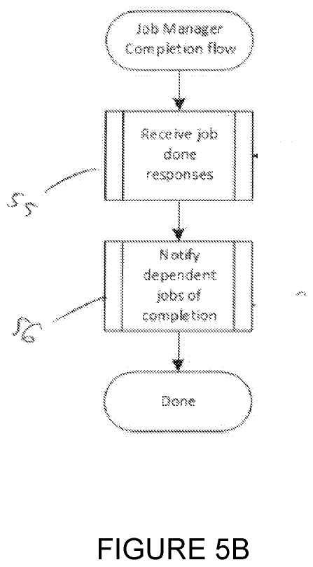

FIG. 5A is a flow chart showing the operation of the job manager circuit (command stream frontend circuit) 35 when issuing processing jobs to the task iterator 20 according to the present embodiments. As shown in FIG. 5A, so long as there are still jobs to issue (step 51—yes), the job manager circuit (command stream frontend circuit) 35 attempts to issue those jobs to the task iterator 20, e.g. as described above. If the job does not strictly depend on any previous jobs, such that there is no need to enforce a strict (hard) dependency (step 52—no), the job can accordingly then be issued to the task iterator 20 that controls the issuing of tasks to the shader cores 38 without necessarily waiting for any previous jobs to complete. Once all jobs have been issued (step 51—no), the job manager issue flow is completed.

As mentioned above, according to the present embodiments, main processing jobs are no longer considered to be strictly dependent on their corresponding pilot jobs (i.e. pilot jobs within the same processing pass). Thus, in the present embodiments, the job manager circuit (command stream frontend circuit) 35 is operable to issue main processing jobs to the task iterator (i.e. at step 54) without waiting for any pilot jobs on which they depend to have finished. That is, according to the present embodiments, there is no need for an explicit ‘wait’ command to be inserted between a ‘run_fragment pilot’ command and any dependent main ‘run_fragment’ commands in the same processing pass, and so the command stream associated with that processing pass may, e.g., be as follows;
run_fragment pilot
run_fragment
. . .

On the other hand, there may be some instances where a strict (hard) barrier should still be enforced within the graphics processor command stream and the job manager circuit (command stream frontend circuit) 35 is accordingly operable and configured to do this (i.e. at step 52).

An example of this would be before issuing any new pilot jobs, e.g. for a subsequent processing pass, since in that case it may still be required to enforce a strict (hard) barrier ahead of issuing a new pilot job. For instance, in the example shown in FIG. 4, a single reference counter 420 is used to track how many pilot jobs are currently in-flight without attempting to track which processing pass these pilot jobs relate to. In this situation, it may in fact be safe to issue a pilot job for a later processing pass for processing concurrently with main processing jobs for the previous processing pass that have not yet finished (since main processing jobs will typically only have a dependency on the corresponding pilot shader programs within the same processing pass). However, the coarse tracking shown in FIG. 4 is not able to determine which processing pass the pilot job that is currently in-flight relates to. Thus, in this situation, a strict (hard) barrier is removed between a pilot job and its subsequent main processing jobs within the same processing pass, but a strict (hard) barrier is still enforced between processing passes. For example, in the case where there are two processing passes, and the later processing pass has a dependency on the earlier processing pass, the typical command stream in this case may, e.g., be as follows:
run_fragment pilot 1 for processing pass 1
run_fragment main 1 for processing pass 1
wait for all jobs for processing pass 1 to finish
run_fragment pilot 1 for processing pass 2
run_fragment main 1 for processing pass 2
. . .

In this case, when it is determined that a strict dependency should be enforced (step 52—yes), the job manager circuit (command stream frontend circuit) 35 should then, and does, wait for any previous jobs to complete (step 53) before issuing the dependent job to the task iterator for processing (step 54).

It may also be possible in the case where there are two processing passes, and the later processing pass has a dependency on the earlier processing pass to determine whether or not the pilot shader program for the later processing pass has any dependencies on the earlier processing pass. If not, the ‘wait’ command may then be moved further back, e.g. as follows;
run_fragment pilot 1 for processing pass 1
run_fragment main 1 for processing pass 1
run_fragment pilot 1 for processing pass 2
wait for all jobs for processing pass 1 to finish
run_fragment main 1 for processing pass 2
. . .

This then allows the pilot shader job for the later processing pass to be issued ahead of time which will also avoid the problem of low shader core utilisation.

Thus, there are various examples of possible dependencies where it may still be desired to enforce a stricter (harder) processing barrier between processing jobs within the graphics processor command stream, and this can be done, e.g. as normal, e.g. by inserting suitable ‘wait’ commands into the graphics processor command stream. These ‘wait’ commands then cause the job manager circuit (command stream frontend circuit) 35 to wait for any previous jobs that are causing possible dependencies to finish before issuing the next job to the task iterator 20.

FIG. 5B is a flow chart showing the corresponding completion flow for the job manager circuit (command stream frontend circuit) 35. Thus, as shown in FIG. 5B, the job manager circuit (command stream frontend circuit) 35 is operable to receive (from the task iterator 20) responses when processing jobs complete (step 55). When a processing job that is causing the job manager circuit (command stream frontend circuit) 35 issue flow to stall (i.e. at step 53) completes, the completion status of the job can be notified accordingly (step 56). The wait condition (i.e. at step 53) is thus removed and the dependent jobs can progress.

Various other arrangements would be possible in this regard. For example, in other embodiments, as shown in FIG. 8, the task iterator 20 is operable and configured to maintain a set of reference counters 820 that track on a per-processing pass basis whether or not any pilot jobs are currently in-flight. Thus, as shown in FIG. 8, each reference counter in the set of reference counters 820 is associated with a respective job identifier. In this case, it is possible to track and enforce dependencies within individual processing passes. In that case, it may then be permitted to issue a pilot job for a later processing pass for processing concurrently with main processing jobs for an earlier processing pass.

As described above, the job manager circuit (command stream frontend circuit) 35 issues jobs to the task iterator 20 which then breaks the jobs into respective processing tasks for scheduling to respective shader cores 38.

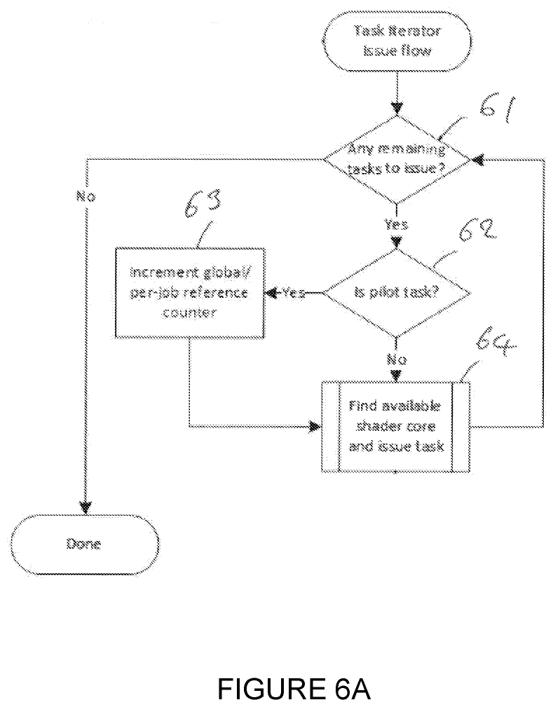

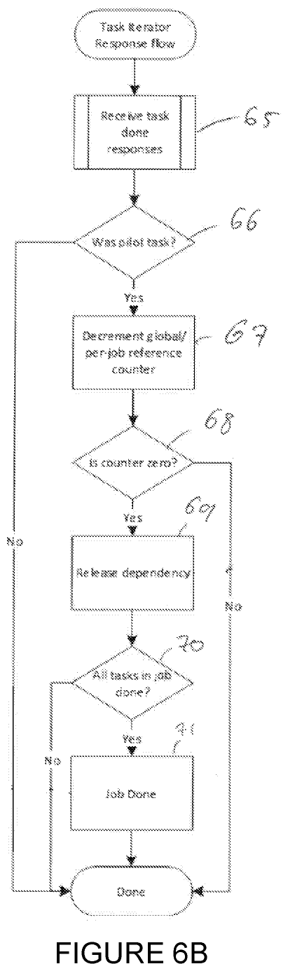

FIG. 6A is a flow chart showing the operation of the task iterator 20 when issuing processing tasks to respective shader cores 38 according to the present embodiments. The task iterator 20 issue flow is thus triggered by the task iterator 20 receiving jobs from the job manager circuit (command stream frontend circuit) 35 (i.e. by step 54 in FIG. 5A).

As shown in FIG. 6A, so long as there are tasks to issue (step 61—yes), the task iterator 20 attempts to schedule the task to a respective shader core 38 for processing. As part of this, it is checked (at step 62) whether or not the task relates to a pilot job. If the task is a pilot job, the reference counter 420 (or respective reference counter from the set of references counter 820) may be incremented accordingly (step 63) before issuing the task to an available shader core 38 for processing (step 64). On the other hand, if the task does not relate to a pilot job, the task is simply issued to an available shader core 38 for processing (step 64) without updating the reference counter.

FIG. 6B is a flow chart showing the corresponding completion flow for the task iterator 20. As shown in FIG. 6B, the task iterator 20 receives from the shader cores 38 a respective response whenever a task is completed (step 65). If the completed task was not a pilot task (step 66—no), there is no need to perform any further notification, and the completion flow is done. Whereas, if the completed task was a pilot task (step 66—yes), the reference counter 420 (or respective reference counter from the set of references counter 820) is accordingly decremented (step 67).

The reference counter thus tracks how many tasks associated with pilot jobs are currently being processed. (It will be appreciated here that a pilot job may, and typically will, only contain a single task, and so tracking the number of tasks associated with pilot jobs currently in-flight is generally equivalent to tracking the number of pilot jobs currently in-flight. However, in principle, it would also be possible to explicitly track how many pilot jobs are currently in-flight at the job level. Various arrangements would be possible in this regard.)

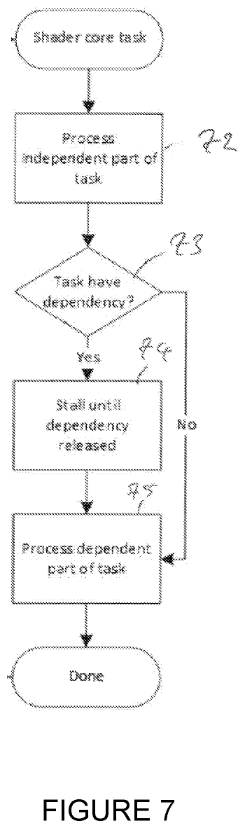

This tracking can accordingly be used to enforce dependencies between pilot jobs and dependent main processing jobs as required within the shader core 38. For instance, FIG. 7 is a flow chart showing the processing control for a task within a shader core 38. In this example, and in general, a task may be divided into a set of frontend operations that can safely be processed independently of any earlier pilot jobs and a set of dependent operations that require the results of an earlier pilot job. For instance, the independent operations may include operations performed in the fragment frontend 30 of the shader core 38, whereas the dependent operations may include execution of the main shader program within the execution engine 31 of the shader core 38.

When a task is issued to the shader core 38, the independent part of the task can thus be (and is) processed (step 72) immediately. If the task has no active dependencies (step 73—no), it is safe to continue processing the dependent part of the task (and so this is done) (step 75). Once the dependent part of the task has been processed (i.e. at step 75), the task is done and this is signalled back to the task iterator 20 (i.e. at step 65). However, in the case that the task has an active dependency (step 73—yes), processing of the task should then be stalled (step 74) until the dependency is released, such that the processing of the dependent part of the task (i.e. at step 75) is gated pending the dependency being released.

In the present embodiments, therefore, when the task iterator 20 issues a task to a shader core 38 for processing, if the task has an active dependency (e.g. because there is currently a pilot job in-flight on which it depends), the task is in embodiments then annotated accordingly as having a dependency. For instance, this can be done by setting a suitable dependency bit, wherein if this dependency bit is set, processing of the task stalls within the shader core 38 (i.e. at step 74) until the dependency is released. Conversely, if the dependency bit is cleared, the processing of the task does not stall (i.e. at step 73 it is determined that there is no dependency). The dependency bit can thus be used to indicate whether or not the task has an active dependency that means that processing of the dependent part of the task should be stalled within the shader core 38.

Thus, if the reference counter that is maintained by the task iterator 20 indicates at the point at which a task is issued to a shader core 38 for processing that there is a pilot job currently in-flight such that the task has an active dependency (i.e. the relevant reference counter is non-zero), processing of the task is stalled within the shader core 38 (i.e. at step 74) until the dependency is released. At some point during the graphics processing operation the pilot tasks for the pilot job that is causing the dependency will complete and this will be signalled to the task iterator to cause the reference counter to be decremented (i.e. at step 67). Once all of the pilot tasks have completed, and the reference counter is hence decremented to zero (step 68), this means that the dependency can be released, and this is accordingly signalled to any waiting shader cores 38 (step 69) to release the dependency (i.e. at step 74).

Once all tasks in the job are done (step 70—yes), the job is done and this can be signalled back to the job manager circuit (command stream frontend circuit) 35 accordingly (step 71) to release any waiting jobs (i.e. by triggering the job manager circuit (command stream frontend circuit) 35 completion flow shown in FIG. 5B).

According to the technology described herein, therefore, it is possible to remove a strict (hard) barrier within the graphics processor command stream between pilot jobs and subsequent main processing jobs within the same processing pass, with any dependencies between main and pilot jobs then being enforced within the shader cores, e.g. as described above. This then allows the graphics processor to effectively run ahead of its current command stream execution and start performing at least some processing of dependent main processing jobs without necessarily waiting for any associated pilot shader programs to have finished their execution.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processor comprising a set of one or more processing cores, the method comprising:
when performing a processing pass including one or more initial processing jobs, wherein an initial processing job executes a respective initial shader program that is to be executed in advance of a corresponding “main” shader program that will be executed for a separate “main” processing job within the same processing pass, the “main” shader program thus having a dependency on the initial shader program for the initial processing job, and wherein a “main” processing job comprises a respective set of one or more tasks to be processed for the “main” processing job, each task operable to execute a respective instance of the “main” shader program:
tracking whether any initial processing jobs are currently being processed by the set of one or more processing cores; and
when a respective task to be processed as part of a “main” processing job is issued to a respective processing core for processing whilst the set of one or more processing cores is concurrently performing processing for at least one initial processing job:
controlling processing of the task for the “main” processing job within the processing core based on the tracking whether any initial processing jobs are currently being processed by the set of one or more processing cores such that the “main” shader program for the “main” processing job is not executed in respect of the task at least until any initial processing jobs that were being concurrently processed with the task and on which the “main” shader program has a dependency have finished their processing.

2. The method of claim 1, comprising:
when issuing a task for a “main” processing job to a respective processing core for processing:
determining, based on the tracking, whether any initial processing jobs on which the task has a potential dependency are currently being performed by the set of one or more processing cores; and
when it is determined that at least one initial processing job on which the task has a potential dependency is currently being processed by the set of one or more processing cores at the point at which the task is issued to a respective processing core for processing:
issuing the task to the respective processing core for processing concurrently with the at least one initial processing job that is being processed by the set of one or more processing cores; and
performing at least some processing of the task up to but not including execution of the “main” shader program but waiting at least until the at least one initial processing job that was being performed by the set of one or more processing cores concurrently with the task for the “main” processing job has finished its processing before executing the “main” shader program.

3. The method of claim 2, wherein when it is determined that at least one initial processing job on which the task has a potential dependency is currently being processed by the set of one or more processing cores at the point at which the task is issued to a respective processing core for processing, the method comprises indicating that execution of the “main” shader program for the task should be stalled pending the set of one or more processing cores completing processing the initial processing job or jobs on which the task has a potential dependency, the indicating causing the processing core to stall execution of the “main” shader program until a signal is received to indicate that the set of one or more processing cores has completed processing the initial processing job or jobs on which the task has a potential dependency.

4. The method of claim 3, further comprising: the processing core subsequently receiving a signal to indicate that the set of one or more processing cores has completed processing the initial processing job or jobs on which the task has a potential dependency; and in response to such signal the processing core continuing processing the task including executing the “main” shader program.

5. The method of claim 1, wherein the tracking whether any initial processing jobs are currently being performed by the set of one or more processing cores comprises maintaining a reference counter indicative of how many initial processing jobs are currently being performed by the set of one or more processing cores.

6. The method of claim 1, wherein the tracking whether any initial processing jobs are currently being performed by the set of one or more processing cores is performed by a task issuing circuit that controls issuing of tasks to the set of one or more processing cores.

7. The method of claim 1, wherein the tracking whether any initial processing jobs are currently being processed by the set of one or more processing cores is performed on a per-processing pass basis, such that it is tracked for individual processing passes whether or not any initial processing jobs are currently being processed by the set of one or more processing cores for that processing pass, and wherein the controlling processing of the task for the “main” processing job comprises controlling processing of the task based on the tracking whether or not any initial processing jobs are currently being processed by the set of one or more processing cores for the same processing pass including the “main” processing job.

8. The method of claim 1, wherein the sequence of processing jobs includes a first processing pass including one or more initial processing jobs and one or more subsequent “main” processing jobs and a second processing pass including one or more initial processing jobs and one or more subsequent “main” processing jobs, and wherein a processing barrier is enforced between the first and second processing passes so that an initial processing job for the second processing pass is not issued for processing concurrently with any processing jobs for the first processing pass.

9. The method of claim 1, wherein a processing barrier is enforced in the sequence of processing jobs ahead of any initial processing job in the sequence of processing jobs such that initial processing jobs are not issued for processing concurrently with any earlier processing jobs in the sequence of processing jobs.

10. The method of claim 1, wherein the “main” processing jobs are fragment rendering jobs in which a fragment shader program is to be executed.

11. A graphics processor comprising:
a set of one or more processing cores;
a task issuing circuit operable and configured to issue tasks to the set of one or more processing cores for processing; and
a control circuit,
wherein the control circuit is configured to:
when the graphics processor is performing a processing pass including one or more initial processing jobs, wherein an initial processing job executes a respective initial shader program that is to be executed in advance of a corresponding “main” shader program that will be executed for a separate “main” processing job within the same processing pass, the “main” shader program thus having a dependency on the initial shader program for the initial processing job, and wherein a “main” processing job comprises a respective set of one or more tasks to be processed for the “main” processing job, each task operable to execute a respective instance of the “main” shader program:
track whether any initial processing jobs for the current processing pass are currently being processed by the set of one or more processing cores; and
control processing of tasks for “main” processing jobs within the processing cores based on the tracking whether any initial processing jobs for the current processing pass are currently being processed by the set of one or more processing cores such that, when a respective task to be processed as part of a “main” processing job is issued to a respective processing core for processing whilst the set of one or more processing cores is concurrently performing processing for at least one initial processing job within the same processing pass as the “main” processing job for which the task is being performed:
the “main” shader program for the “main” processing job is not executed in respect of the task at least until any initial processing jobs for the current processing pass and on which the “main” shader program has a dependency have finished.

12. The graphics processor of claim 11, comprising:
when issuing a task for a “main” processing job to a respective processing core for processing:
determining, based on the tracking, whether any initial processing jobs on which the task has a potential dependency are currently being performed by the set of one or more processing cores; and
when it is determined that at least one initial processing job on which the task has a potential dependency is currently being processed by the set of one or more processing cores at the point at which the task is issued to a respective processing core for processing:
issuing the task to the respective processing core for processing concurrently with the at least one initial processing job that is being processed by the set of one or more processing cores; and
performing at least some processing of the task up to but not including execution of the “main” shader program but waiting at least until the at least one initial processing job that was being performed by the set of one or more processing cores concurrently with the task for the “main” processing job has finished its processing before executing the “main” shader program.

13. The graphics processor of claim 12, wherein when it is determined that at least one initial processing job on which the task has a potential dependency is currently being processed by the set of one or more processing cores at the point at which the task is issued to a respective processing core for processing, the method comprises indicating that execution of the “main” shader program for the task should be stalled pending the set of one or more processing cores completing processing of the initial processing job or jobs on which the task has a potential dependency, the indicating causing the processing core to stall execution of the “main” shader program until a signal is received to indicate that the set of one or more processing cores has completed processing the initial processing job or jobs on which the task has a potential dependency.

14. The graphics processor of claim 13, further comprising: the processing core subsequently receiving a signal to indicate that the set of one or more processing cores has completed processing the initial processing job or jobs on which the task has a potential dependency; and in response to such signal the processing core continuing processing the task including executing the “main” shader program.

15. The graphics processor of claim 11, wherein the tracking whether any initial processing jobs are currently being performed by the set of one or more processing cores comprises maintaining a reference counter indicative of how many initial processing jobs are currently being performed by the set of one or more processing cores.

16. The graphics processor of claim 11, wherein the tracking whether any initial processing jobs are currently being performed by the set of one or more processing cores is performed by a task issuing circuit that controls issuing of tasks to the set of one or more processing cores.

17. The graphics processor of claim 11, wherein the control circuit is configured to track whether any initial processing jobs are currently being processed by the set of one or more processing cores is performed on a per-processing pass basis, such that it is tracked for individual processing passes whether or not any initial processing jobs are currently being processed by the set of one or more processing cores for that processing pass, the control circuit then configured to control processing of tasks for “main” processing jobs based on the tracking whether or not any initial processing jobs are currently being processed by the set of one or more processing cores for the same processing pass including the “main” processing job.

18. The graphics processor of claim 11, wherein the sequence of processing jobs includes a first processing pass including one or more initial processing jobs and one or more subsequent “main” processing jobs and a second processing pass including one or more initial processing jobs and one or more subsequent “main” processing jobs, and wherein a processing barrier is enforced between the first and second processing passes so that an initial processing job for the second processing pass is not issued for processing concurrently with any processing jobs for the first processing pass.

19. The graphics processor of claim 11, wherein a processing barrier is enforced in the sequence of processing jobs ahead of any initial processing job in the sequence of processing jobs such that initial processing jobs are not issued for processing concurrently with any earlier processing jobs in the sequence of processing jobs.

20. A non-transitory computer readable medium storing computer software code that when executed on one or more data processor will cause the data processor to perform a method of operating a graphics processor comprising a set of one or more processing cores, the method comprising:
when performing a processing pass including one or more initial processing jobs, wherein an initial processing job executes a respective initial shader program that is to be executed in advance of a corresponding “main” shader program that will be executed for a separate “main” processing job within the same processing pass, the “main” shader program thus having a dependency on the initial shader program for the initial processing job, and wherein a “main” processing job comprises a respective set of one or more tasks to be processed for the “main” processing job, each task operable to execute a respective instance of the “main” shader program:
tracking whether any initial processing jobs are currently being processed by the set of one or more processing cores; and
when a respective task to be processed as part of a “main” processing job is issued to a respective processing core for processing whilst the set of one or more processing cores is concurrently performing processing for at least one initial processing job:
controlling processing of the task for the “main” processing job within the processing core based on the tracking whether any initial processing jobs are currently being processed by the set of one or more processing cores such that the “main” shader program for the “main” processing job is not executed in respect of the task at least until any initial processing jobs that were being concurrently processed with the task and on which the “main” shader program has a dependency have finished their processing.
